(19) United States
(12) Patent Application Publication
(10) Pub. No.: US 2026/0150923 A1
(43) Pub. Date: Jun. 4, 2026

(54) NONWOVEN WEARABLE ARTICLES WITH ZONAL PROPERTIES AND SYSTEMS AND METHODS FOR MANUFACTURING

(71) Applicant: NIKE, Inc., Beaverton, OR (US)

(72) Inventors: Dallas Lund, Portland, OR (US); Shyam A. Patel, Sacramento, CA (US)

(21) Appl. No.: 19/407,435

(22) Filed: Dec. 3, 2025

Related U.S. Application Data
(60) Provisional application No. 63/728,011, filed on Dec. 4, 2024.

(51) Int. Cl. A41D 31/02; A41D 3/00; A41D 27/00; B32B 5/02; B32B 5/12; B32B 5/26; B32B 7/09; D04H 1/4374; D04H 1/74

(52) U.S. Cl. CPC A41D 31/02; A41D 3/005; A41D 27/00; B32B 5/022; B32B 5/12; B32B 5/267; B32B 7/09; D04H 1/4374; D04H 1/74; B32B 2437/00; D10B 2501/04

(57) ABSTRACT

Wearable apparel (e.g., footwear, upper-torso garment, lower-torso garment, etc.) can include a composite textile that has zonal properties and that includes one or more nonwoven portions. For example, a wearable apparel can be constructed of one or more pattern pieces including the composite textile, and a given pattern piece can have a plurality of different zones or regions. Examples of the present disclosure are related to varied properties as between two or more zones of a pattern piece based on one or more fiber properties (e.g., orientation, shape, composition, denier, color, finish, basis weight, etc.). In examples, a gantry system can be used to deposit fibers at select locations to construct the zones.

### CROSS REFERENCE TO RELATED APPLICATIONS

This application claims the priority benefit of U.S. Provisional Application No. 63/728,011 (filed Dec. 4, 2024), which is hereby incorporated herein by reference in its entirety.

### TECHNICAL FIELD

This disclosure relates wearable articles (e.g., footwear, upper-torso garments, lower-torso-garments, etc.) having textiles with fibers imparting zonal properties and systems and methods for manufacturing.

### BACKGROUND

Conventional nonwoven textiles are constructed as rolled goods, and finished products can be created by cutting pattern pieces from the rolled good. In some instances, one or more fiber webs can be stacked and entangled to form a composite nonwoven textile. Often properties are relatively consistent as between different regions of the composite nonwoven textile (e.g., different unit areas or unit volumes).

### BRIEF DESCRIPTION OF THE FIGURES

Examples of the present disclosure are described in detail in the Detailed Description below with reference to these drawing figures.

FIG. 1 illustrates an example manufacturing process using a gantry and fiber-delivery head, based on an example.

FIG. 2 illustrates an enlarged, partial perspective view of the gantry and the fiber-delivery head, based on an example.

FIG. 2A illustrates an enlarged, partial view of the gantry and the fiber-delivery head, from a different perspective, based on an example.

FIG. 3 illustrates a view similar to FIG. 2 but with portions removed to reveal details of construction, based on an example.

FIG. 4 illustrates a cross-sectional view along line 4-4 of FIG. 3, based on an example.

FIG. 5A illustrates a bottom plan view showing one aspect of a bottom plate on the fiber-delivery head, based on an example.

FIG. 5B illustrates a bottom plan view showing one aspect of a bottom plate on the fiber-delivery head, based on an example.

FIG. 6 illustrates an enlarged view of the encircled region 6 of the substrate of FIG. 1, based on an example.

FIG. 7A illustrates a cross-sectional view of one aspect of the substrate taken along line 7-7 of FIG. 6, based on an example.

FIG. 7B illustrates a cross-sectional view of another aspect of the substrate taken along line 7-7 of FIG. 6, based on an example.

FIG. 8A illustrates a cross-sectional view of one aspect of the substrate taken along line 8-8 of FIG. 6, based on an example.

FIG. 8B illustrates a cross-sectional view of another aspect of the substrate taken along line 8-8 of FIG. 6, based on an example.

FIG. 9A illustrates an enlarged view of one aspect of the bristles of the substrate, based on an example.

FIG. 9B illustrates an enlarged view of another aspect of the bristles of the substrate, based on an example.

FIG. 10 illustrates an enlarged view of an example interaction between needles and the bristles of the substrate, based on an example.

FIG. 11 illustrates a method of manufacturing a nonwoven textile, based on an example.

FIG. 12 illustrates a wearable article having zonal nonwoven constructions, based on an example.

FIG. 13 illustrates a method of constructing a composite textile with zonal nonwoven portions, based on an example.

FIG. 14A illustrates an example of a composite textile with zonal nonwoven constructions, based on an example.

FIG. 14B illustrates a cross-section associated with the composite textile in FIG. 14A, based on an example.

FIG. 15A illustrates an example of a composite textile with zonal nonwoven constructions, based on an example.

FIG. 15B illustrates a cross-section associated with the composite textile in FIG. 15A, based on an example.

FIG. 16A illustrates an example of a composite textile with zonal nonwoven constructions, based on an example.

FIG. 16B illustrates a cross-section associated with the composite textile in FIG. 16A, based on an example.

FIG. 17A illustrates an example of a composite textile with zonal nonwoven constructions, based on an example.

FIG. 17B illustrates a cross-section associated with the composite textile in FIG. 17A, based on an example.

FIG. 18 illustrates an example of a composite textile with varied and tailored fiber orientation, based on an example.

FIG. 19 illustrates an approach to assessing fiber orientation, based on an example.

FIG. 20 illustrates a wearable article with fibers oriented relative to a peripheral border, based on an example.

FIG. 21 illustrates a composite textile with varied zonal fiber orientation, based on an example.

### DETAILED DESCRIPTION

This disclosure is related to wearable articles (e.g., footwear, upper-torso garment, lower-torso garment, etc.) including a composite textile that has zonal properties and that includes one or more nonwoven portions, as well as systems and methods for constructing the textile. For example, a wearable article can be constructed of one or more pattern pieces including the composite textile, and a given pattern piece can have a plurality of different zones or regions. Examples of the present disclosure are related to varied properties as between two or more zones of a pattern piece based on one or more fiber properties (e.g., orientation, shape, composition, denier, color, finish, basis weight, etc.). In examples, a gantry system can be used to deposit fibers at select locations to construct the zones.

Conventional nonwoven textiles are generally manufactured into large, rolled sheets or bolts having uniform properties. The uniform properties result from a consistent fiber material, fiber layer depth, and/or fiber orientation as the nonwoven textile is manufactured. For example, a homogenous mix of fibers is typically distributed onto a substrate (e.g., conveyored substrate). The fibers can be carded, cross-lapped, pre-needled, and/or entangled with other fiber webs. The overall makeup of fibers in the resulting conventional nonwoven textile is generally homogenous. Applying conventional approaches, a pattern piece for wearable apparel can be cut from the bolt of nonwoven textile, and the fiber properties associated with the pattern piece are likewise overall homogenous. For example, fiber properties (e.g., fiber orientation(s), fiber composition(s), fiber shape(s), fiber denier(s), fiber diameter(s), fiber color(s), etc.) associated with a first zone of the pattern piece will often be generally consistent with fiber properties associated with a second zone of the pattern piece (e.g., on account of it being cut from the homogenous rolled good).

Conventional approaches can have various drawbacks. For example, it can be challenging to create, with a nonwoven textile or with a composite textile having nonwoven portions, a pattern piece that includes zonal properties. In addition, cutting pattern pieces from conventional rolled goods can result in significant waste from the scrap and remnant portions.

In contrast to conventional approaches, the present disclosure includes a system for creating a nonwoven textile (e.g., a composite textile that includes one or more nonwoven layers or portions), including a fiber-delivery head coupled to a gantry. The gantry is operable to move the fiber-delivery head. The system may also include, in some aspects, a substrate below the fiber-delivery head, the substrate having a surface defining an x-y plane that supports fibers from the fiber-delivery head. The gantry moves the fiber-delivery head above the substrate in at least an x-y plane, and in some instances, the gantry can also move in the z direction (e.g., vertical direction orthogonal to the x-y plane) and/or adjust the angle of the fiber-delivery head. With this movement, the fiber-delivery head can distribute fibers directionally based on movement of the fiber-delivery head in the x-y plane and/or in one or more other axes. As such, a resulting textile can include zones having different fiber orientations that are not tied to a machine direction (e.g., the machine direction in a conventional nonwoven manufacturing process).

In other aspects, the fiber-delivery head includes (or is otherwise operationally associated with) a fiber-separator system that selectively separates fibers from a collection of fibers or “fiber collection” (e.g., from a sliver, roving, or other collection of fibers from which fibers can be separated for distribution or deposit). In some aspects, the fiber-separator system can separate fibers from fiber collections that include different materials, such as a first fiber collection of a first material and a second fiber collection of a second material). In some aspects, the first material and the second material have different properties. In some aspects, the fiber-separator system selectively feeds at least one fiber collection of a plurality of fibers collections, and separates fibers from the selected at least one fiber collection of the plurality of fiber collections. In some aspects, each fiber collection of the plurality of fiber collections is a different material. In other aspects, the fiber-separator system selectively and simultaneously feeds at least two fiber collections of the plurality of fiber collections and separates fibers from the selected at least two fiber collections. For instance, the fiber collection or fiber collections selected may deliver fibers having different properties, including different deniers, materials, colors, or coatings (e.g. silicone-coated fibers). Such a fiber selection may be based upon properties desired in the pattern or garment at the delivery location (e.g., expected abrasion forces, feel, drapability, etc.). As such, a resulting textile can include zones having fibers with different fiber properties based on the controllable deposition of different fiber types.

The fiber-separator system may include, in some aspects, a pair of opposed feed rollers. In some aspects, at least one of the feed rollers is selectively driven by a motor. The feed rollers may include a textured surface that separates fibers from a corresponding fiber collection. In some aspects, the motors coupled to the feed rollers are individually controllable (to feed a selected fiber collection corresponding to the feed roller(s)). The feed rate of the fiber collections through the fiber-delivery head may be controlled by the motor. In some aspects, the fiber-delivery head includes a chute below the fiber separator system, the chute directing the separated fibers to an outlet.

In some aspects, the fiber-delivery head further includes a propulsion system, such as compressed air, coupled to the delivery head, to move separated fibers down the chute. The fiber-delivery head may further include, in some aspects, a bottom plate below the chute, the bottom plate having at least one nozzle that directs the separated fibers onto the substrate. In some aspects, the bottom plate includes multiple nozzles that may be selectively positioned below the chute. Each of the multiple nozzles may have a different size, shape or configuration.

In some aspects, the fiber-delivery head may include one or more fiber processing modules, such as one or more entanglement heads (e.g., needle-punch heads, hydro-entanglement heads, etc.). In some aspects, the fiber-delivery head also includes a roller coupled to a downstream side, the roller having a wheel positioned to interact with the fibers delivered to the substrate. In some aspects, the substrate is a bed of spaced, flexible bristles.

Other aspects herein are directed to a method of manufacturing a nonwoven textile. The method includes, in some aspects, delivering selected fibers onto a substrate in pattern, created by moving a fiber-delivery head in an x-y plane (or other axes) above the substrate, and entangling the selected fibers to create a nonwoven textile in the shape of the pattern. In some aspects, the method includes selectively feeding at least one of a plurality of fiber collections (e.g., sliver, roving, batch of loose fibers, etc.) into the fiber-delivery head. In other aspects, the method includes feeding two or more of a plurality of fiber collections into the fiber-delivery head. In some aspects, the method includes determining a desired orientation for the selected fibers, and moving the fiber-delivery head in the x-y plane (or other axes) above the substrate based on the determined desired fiber orientation. In other aspects, the method includes determining a desired fiber density at a location on the pattern, and adjusting the rate of movement of the fiber-delivery head in the x-y plane (or other axes) above the substrate based on the determined fiber density. In some aspects, the method includes determining a desired fiber density at a location on the pattern, and adjusting the rate of feeding the selected fiber collection(s) into the fiber-delivery head. In some aspects, the method includes delivering a first composition of fibers in at least a first location and a second composition of fibers in a second location, to create different zonal properties in the first location as compared to the zonal properties in the second location. In some aspects, the method includes selectively feeding the separated fibers through a nozzle. The method may include, in some aspects, selecting one of a plurality of spray patterns for the separated fibers, and delivering the fibers through a nozzle selected based on the selected spray pattern. In some aspects, the entangling includes, in a first entanglement step, mechanically entangling a plurality of the fibers with a first number of needles across the pattern, and subsequent to the first entanglement step, mechanically entangling a plurality of the fibers in an area that is a subset of the pattern with a second number of needles. In some aspects, the first number of needles is larger than the second number of needles.

As used herein, the term “article of apparel” is intended to encompass articles worn by a wearer, which can also be referred to as “wearable articles” or “wearable apparel.” Wearable articles can include, among other things, upper-body garments (e.g., tops, t-shirts, pullovers, hoodies, jackets, coats, vests, and the like), lower-body garments (e.g., pants, shorts, tights, capris, unitards, and the like), hats, gloves, sleeves (e.g., arm sleeves, calf sleeves), articles of footwear (e.g., uppers for shoes), and the like. As used herein, the term “finished goods” may include articles of apparel or wearable articles, equipment such as bags, furniture, and other such items. As used herein, the term “roll goods” may include, for example, composite textiles (e.g., including one or more nonwoven layers) that have been formed into a cohesive structure (e.g., by carding, lapping, and/or light needling) and rolled onto a core.

A “pattern piece” is a discrete piece of textile that includes a shape configured to form a portion of an article. A pattern piece can be cut to shape from a larger piece of textile, such as a roll good or a blank. In some instances, a pattern piece can include a discrete piece after edges or outer margins have been trimmed off (or otherwise removed). In some examples of the present disclosure, a pattern piece is formed to shape. For example, the pattern piece can include layers (e.g., fiber layers) with fibers that are deposited (e.g., sprayed) to shape (e.g., via a gantry system), entangled to-shape (e.g., needle-punched to shape), and the like. In addition, in some examples of the present disclosure, a pattern piece is formed to shape via an additive process in which layers are deposited to shape, one on top of the other. A pattern piece can also be referred to as a “panel.” Examples of pattern pieces, such as for an upper-body garment, can include a front panel, a back panel, a sleeve, and the like.

The term “inner-facing surface” when referring to the wearable article means the surface that is configured to face mostly towards a body surface of a wearer, and the term “outer-facing surface” means the surface that is configured to face mostly away from the body surface of the wearer and toward an external environment. The term “innermost-facing surface” means the surface closest to the body surface of the wearer with respect to other layers of the wearable article, and the term “outermost-facing surface” means the surface that is positioned farthest away from the body surface of the wearer with respect to the other layers of the wearable article.

As used in this disclosure the terms “filament,” “fiber,” or “fibers” refer to materials or structures that are in the form of discrete elongated pieces that are significantly longer than they are wide. A fiber can include natural, manmade or synthetic fibers. The fibers may be produced by conventional techniques, such as extrusion, electrospinning, interfacial polymerization, pulling, and the like.

Fibers can include carbon fibers, boron fibers, silicon carbide fibers, titania fibers, alumina fibers, quartz fibers, glass fibers, such as E, A, C, ECR, R, S, D, and NE glasses and quartz, or the like. The fibers can be fibers formed from synthetic polymers capable of forming fibers such as poly(ether ketone), polyimide, polybenzoxazole, poly(phenylene sulfide), polyesters (e.g., polyethylene terephthalate (PET)), polyolefins (e.g., polyethylene, polypropylene), aromatic polyamides (e.g., an aramid polymer such as para-aramid fibers and meta-aramid fibers), aromatic polyimides, polybenzimidazoles, polyetherimides, polytetrafluoroethylene, acrylic, modacrylic, poly(vinyl alcohol), polyamides, polyurethanes, and copolymers such as polyether-polyurea copolymers, polyester-polyurethanes, polyether block amide copolymers, or the like. The fibers can be natural fibers (e.g., silk, wool, cashmere, vicuna, cotton, flax, hemp, jute, sisal). The fibers can be man-made fibers from regenerated natural polymers, such as rayon, lyocell, acetate, triacetate, rubber, and poly(lactic acid). The fibers can include organic polymers. The fibers can include inorganic material fibers.

The fibers may include virgin fibers (fibers that have not been recycled), and/or recycled fibers. Recycled fibers include “shredded-article fibers” and “re-pelletized-polymer fibers.” As used herein, shredded-article fibers include fibers that are direct by-products of shredding a fiber-containing article (e.g., knit, woven, nonwoven, etc.). In some examples, shredded-article fibers may be derived without pelletizing and extrusion through processes that consume less energy, and as such, textiles that incorporate shredded-article fibers may have a lower carbon footprint. Re-pelletized-polymer fibers include fibers that are extruded from pelletized or chipped by-products derived from polymer-containing sources (e.g., polymer-containing bottles or containers; polymer-fiber articles that are knit, woven, nonwoven; roll goods; textile manufacturing scrap; fiber webs at various stages of carding, lapping, pre-needling, and needling; etc.).

Fibers can have an indefinite length. For example, man-made and synthetic fibers are generally extruded in substantially continuous strands. Alternatively, the fibers can be staple fibers, such as, for example, cotton fibers or extruded synthetic polymer fibers can be cut to form staple fibers of relatively uniform length. The staple fiber can have a have a length of about 1 millimeter to 110 millimeters or more as well as any increment therein (e.g., 1-millimeter increments). In some examples, the length is between 30 mm and 60 mm. In some examples, the length is about 38 mm. In some examples, the length is about 51 mm.

A fiber can have any of a variety of cross-sectional shapes. Natural fibers can have a natural cross-section, or can have a modified cross-sectional shape (e.g., with processes such as mercerization). Man-made or synthetic fibers can be extruded to provide a strand having a predetermined cross-sectional shape. The cross-sectional shape of a fiber can affect its properties, such as its softness, luster, and wicking ability. The fibers can have round or essentially round cross sections. Alternatively, the fibers can have non-round cross sections, such as flat, oval, octagonal, rectangular, wedge-shaped, triangular, Y-shape, dog-bone, X-shape, clover shape, star shape, penta-lobal, other multi-lobal, multi-channel, saucer shape, serrated, hollow, core-shell, or other shapes.

Examples of the present disclosure can include “wicking fibers.” In some examples, a wicking fiber can include a fiber with a non-round cross section with surface features (e.g., grooves) that can move moisture via capillary action (e.g., along the fiber surface and/or in combination with an adjacent fiber). Examples of cross-sections that can impart and/or contribute to wicking can include, but are not limited to, flat, ribbon, rectangular, Y-shape, X-shape, star-shape, other multi-lobal, dog-bone shape, saucer shape, clover-shape, multi-channel surface, bean shape, and the like. In some examples, a wicking fiber can include a fiber with a wicking surface finish or other wicking treatment, such as fibers by Unifi Manufacturing, Inc. under the brand name Sorbtek. In some examples, wicking fibers are fibers that, based on AATCC 197, achieve 15 cm<30 minutes after three launderings. In some instances, a fiber is wicking based on it being more hydrophilic than another fiber in a same composite textile or in a fiber blend for a nonwoven textile.

Fibers can be processed. For example, the properties of fibers can be affected, at least in part, by processes such as drawing (stretching) the fibers, annealing (hardening) the fibers, and/or crimping or texturizing the fibers.

A fiber can be a multi-component fiber, such as one comprising two or more co-extruded polymeric materials. The two or more co-extruded polymeric materials can be extruded in a core sheath, islands-in-the-sea, segmented-pie, striped, or side-by-side configuration. A multi-component fiber can be processed in order to form a plurality of smaller fibers (e.g., microfibers) from a single fiber, for example, by remove a sacrificial material or by splitting via entanglement operations.

As used herein, the term “yarn” refers to an assembly formed of one or more fibers, wherein the strand has a substantial length and a relatively small cross-section and is suitable for use in the production of textiles by hand or by machine, including textiles made using weaving, knitting, crocheting, braiding, sewing, embroidery, or ropemaking techniques. Thread is a type of yarn commonly used for sewing.

When referring to fibers, the term denier or denier per fiber is a unit of measure for the linear mass density of the fiber and more particularly, it is the mass in grams per 9000 meters of the fiber. In one example aspect, the denier of a fiber may be measured using ASTM D1577-07. The dtex of a fiber is the mass of an individual fiber in grams per 10,000 meter of fiber length. The diameter of a fiber may be calculated based on the fiber's denier and/or the fiber's dtex. For instance, the fiber diameter, d, in millimeters may be calculated using the formula: d=square root of dtex divided by 100. In general, the diameter of a fiber has a direct correlation to the denier of the fiber (i.e., a smaller denier fiber has a smaller diameter).

Fibers used to construct a textile (e.g., a nonwoven portion of a textile) in accordance with this disclosure can have various denier. In some examples, fibers can have a denier of greater than or equal to about 0.1 D. In some examples, the denier can be about 0.1 D, about 0.2 D, about 0.3 D, about 0.4 D, about 0.5 D, about 0.6 D, about 0.7 D, about 0.8 D, or about 0.9 D. In some examples, the denier can be from about 0.6 D to about 1.0 D, from about 0.7 D to about 0.9 D, or about 0.8 D. In some examples, the denier can be from about 0.1 D to about 3.5 D, from about 1.2 D to about 1.7 D, from about 1.3 D to about 1.6 D, or about 1.5 D. In some examples the denier can be greater than about 3.5 D.

As used herein, the term “nonwoven textile” refers to a textile having fibers that are held together by mechanical and/or chemical interactions without being in the form of a knit, woven, braided construction, or other structured construction. In a particular aspect, the nonwoven textile includes a collection of fibers that are mechanically manipulated to form a mat-like material. Stated differently nonwoven textiles are directly made from fibers. The nonwoven textile may include different webs of fibers formed into a cohesive structure, where the different webs of fibers may have a different or similar composition of fibers and/or different properties. Non-limiting examples of nonwoven textiles can include staple-fiber nonwovens (e.g., formed by carding and needle entanglement or fluid entanglement), spunbond nonwovens, spunlace nonwovens, and melt-blown nonwovens. Stated differently, bonding of the fibers in the nonwoven textile can be achieved with thermal bonding (with or without calendering), fluid-entanglement (e.g., hydro or air), ultrasonic bonding, needlepunching (needlefelting), chemical bonding (e.g., using binders such as latex emulsions or solution polymers or binder fibers or powders), meltblown bonding (e.g., fiber is bonded as air attenuated fibers intertangle during simultaneous fiber and web formation), spun-bond, and any combination thereof.

The term “web of fibers” or “fiber web” refers to a layer of fibers prior to undergoing a mechanical entanglement process with one or more other textile layers (e.g., another nonwoven layer, woven layer, knit layer, etc.). In some examples, the fiber layer can be deposited onto a substrate and then entangled with one or more other textile layers. In some examples, the web of fibers can include fibers that have undergone a carding and lapping process that generally aligns the fibers in one or more common directions that extend along an x, y plane and that achieves a desired basis weight. The web of fibers may also undergo a light needling process or mechanical entanglement process that entangles the fibers of the web to a degree such that the web of fibers forms a cohesive structure that can be manipulated (e.g., rolled on to a roller, un-rolled from the roller, stacked, and the like).

Some examples of this disclosure include fibers that can be deposited onto a substrate (e.g., the fibers can be propelled in a gas or other propulsion medium onto the substrate). In some examples, the fibers that can be deposited onto the substrate are arranged in a collection or bundle, which can take various forms. In some instances, the collection can include loose fibers. In at least some examples, the collection can include a bundle and the bundle can optionally be configured into an elongated form having a significantly longer length than width, such as by combing and/or carding the fibers and drawing into long strips. In some examples, the elongated bundle of fibers can be referred to as a sliver or fiber sliver, which can include a continuous strand or long bundle of loose untwisted textile fibers. The fibers in the sliver can be generally oriented lengthwise and can be generally parallel to one another. In some examples, the fibers in the elongated bundle can be slightly twisted. A long narrow bundle of slightly twisted fibers can be referred to as roving.

As used herein, the term “entangled web of fibers” when referring to a composite textile refers to a web of fibers after it has undergone mechanical entanglement (e.g., needle entanglement, fluid entanglement (e.g., water entangled, air entangled), etc.) with one or more other material layers (e.g., fiber web, continuous filament web, knit textile, woven textile, etc.). As such, a web of entangled fibers may include fibers originally present in the web of fibers forming the layer as well as fibers that are present in other webs of fibers or textiles that have been moved through the entanglement process into the web of entangled fibers. An entangled web of fibers can also be referred to as an “entangled fiber web.” In addition, an entangled web of fibers can also be referred to as a “fiber-web constituent layer,” based on the fiber web being a part, layer, substratum, etc. of a composite textile formed at least in part by the post-entangled layers. Similarly, any layer within a composite textile can be referred to as a “constituent layer,” which can indicate that the layer has been combined as a part, layer, substratum, etc. of the composite textile and that at least some of the material included in the layer might still be present as a component of the given stratum.

Mechanical entanglement processes contemplated herein can include needle entanglement (commonly known as needlepunching) using barbed or structured needles (e.g., forked needles), and/or fluid entanglement (e.g., hydro-entanglement). In aspects contemplated herein, needlepunching may be utilized based on the small denier of the fibers being used and the ability to fine tune different parameters associated with the needlepunching process. Needlepunching generally uses barbed or spiked needles to reposition a percentage of fibers from a generally horizontal orientation (an orientation extending along an x, y plane) to a generally vertical orientation (a z-direction orientation). Referring to the needlepunching process in general, a fiber web can be stacked with one or more other textile layers (e.g., other nonwoven, woven, knit, etc.) and passed between a bed plate and a stripper plate positioned on opposing sides of the stacked web configuration.

Barbed needles, which are fixed to a needle board, pass in and out through the stacked web configuration, and the stripper plate strips the fibers from the needles after the needles have moved in and out of the stacked web configuration. As used herein, a “needle-punch tool” can refer to a tool that can hold one or more barbed needles and that can be moved by one or more actuators to effect a needle-punch process. In examples, a needle-punch tool can include a needle board, which can be assembled with one or more other components for operating the needles. The distance between the stripper plate and the bed plate may be adjusted to control web compression during needling. The needle board repeatedly engages and disengages from the stacked web configuration (e.g., as the stacked web configuration is moved or as the needle board is moved) such that the length of the stacked web configuration is needled.

Parameters associated with particular needle boards may be adjusted to achieve desired properties of the resulting needled nonwoven textile (e.g., basis weight, thickness, and the like). The different parameters may include stitch density (SD) which is the number of needles per cm² (n/cm²) used during an entanglement pass and penetration depth (PD) which is how far the needle passes through the stacked web configuration before being pulled out of the stacked web configuration. Parameters associated with the needlepunching process in general may also be adjusted such as the spacing between the bed plate and the stripper plate and/or the speed of conveyance of the stacked web configuration and/or the speed of the needle board (e.g., when associated with a gantry system).

Examples of this disclosure contemplate using a barbed needle (a needle having a pre-set number of barbs arranged along a length of the needle) although other needle types are contemplated herein. The barbs on the needle “capture” fibers as the barb moves from a first face to an opposing second face of the stacked web configuration. The movement of the needle through the stacked web configuration effectively moves or pushes fibers captured by the barbs from a location near or at the first face to a location near or at the second face and further causes physical interactions with other fibers helping to “lock” the moved fibers into place through, for example, friction.

It is also contemplated herein that the needles may pass through the stacked web configuration from the second face toward the first face. In example aspects, the number of barbs on the needle that interact with fibers may be based on the penetration depth of the needle. For example, all the barbs may interact with fibers when the penetration depth is a first amount, and fewer than all the barbs may interact with fibers as the penetration depth decreases.

In further example aspects, the size of the barb may be adjusted based on the denier of fibers used in the web(s). For example, the barb size may be selected so as to engage with small denier (e.g. fine) fibers but not with large denier fibers so as to cause selective movement of the small denier fibers but not the large denier fibers. In another example, the barb size may be selected so as to engage with both small denier and large denier fibers so as to cause movements of both fibers through the webs.

After entanglement, the nonwoven textile may include a first face and an opposite second face which both face outward with respect to an interior of the nonwoven textile and comprise the outermost faces of the nonwoven textile. As such, when viewing the nonwoven textile, the first face and the second face are each fully visible. The first face and the second face may both extend along x, y planes that are generally parallel and offset from each other. For instance, the first face may be oriented in a first x, y plane and the second face may be oriented in a second x, y plane generally parallel to and offset from the first x, y plane.

The term “functional layer” as used herein refers to a layer of material that can be combined with a textile layer (e.g., knit, woven, nonwoven, braided, etc.) to form a composite textile having one or more properties different than the textile layer alone. The functional layer can include various forms, such as a textile (e.g., knit, woven, nonwoven, braided, etc.) or a film.

The functional layer can be combined with, or bonded to, the textile layer in various manners. For example, the functional layer can be bonded via mechanical bonding, thermal bonding, and chemical bonding. An example of a mechanical bond can include fiber entanglement or some adhesives. An example of a thermal bond can include part of the textile layer and/or part of the functional layer being heated to at least a softening point and resolidifying after mixing with, or flowing around, the other layer. In some examples, thermal bonding can include via a hot melt film. In some examples, chemical bonding can include via an adhesive. Functional layers can be used to affect, or impart, various properties to the composite, such as elasticity (e.g., stretch and recovery), stability (e.g., the ability to stretch without breaking), abrasion resistance, water resistance, water repellency, water proofness, etc.

The term “elastomeric layer” as used herein refers to a functional layer that has stretch and recovery properties (e.g., is elastically resilient) in at least one orientational axis, which includes both a layer having stretch and recovery in a single orientational axis and a layer having stretch and recovery in multiple orientational axes. Examples of an orientational axis include a length direction, a width direction, an x-direction, a y-direction, and any direction angularly offset from a length direction, a width direction, an x-direction, and a y-direction. In some examples, a functional layer can include an elastomeric layer and can also impart other properties to the composite.

The elastomeric layer may be formed from thermoplastic polymers, such as thermoplastic elastomers (TPE). Examples of thermoplastic elastomers can include thermoplastic polyurethane (TPU), thermoplastic polyether ester elastomer (TPEE), combinations of TPU and TPEE and the like. Other examples of thermoplastic elastomers can include styrene block copolymers (TPE-S), thermoplastic polyolefins (TPO), thermoplastic vulcanisates (TPV), and melt processable rubber (MPR), thermoplastic polyether block amides (TPE-A). The elastomeric layer may comprise a spunbond layer, a meltblown layer, a film, a web, a scrim, and the like.

In example aspects, the elastomeric layer may include a nonwoven layer that is spunbond, meltblown, and the like. These elastomeric layers that are nonwoven can be referred to as “continuous filament webs,” in contrast to “fiber webs” that might include shorter staple fibers. In some examples, the elastomeric layer can include a spunbond TPEE or a meltblown TPU or a spunbond TPU. In some examples, the spunbond or meltblown continuous filament web can include a blend of a more elastomeric material (e.g., TPU, TPEE, etc.) and a less elastomeric material (e.g., polyester). For example, a more elastomeric material (e.g., TPU, TPEE, etc.) can be introduced via first nozzles and a less elastomeric material (e.g., polyester or polyamide) can be introduced via second nozzles. In some examples, nonwoven elastomeric materials such as a spunbond TPEE or a meltblown TPU or spunbond TPU allow for lower basis weights than elastomeric films. As well, they are generally more breathable and permeable due to the fibrous nature of the web versus a film, and they are generally more pliable (e.g., less stiff) than films. These factors (low basis weight, breathable and permeable, pliable) make them ideal for use in the example composite nonwoven textile described herein especially in the apparel context where these are desirable features.

In some examples, the elastomeric layer can include a fiber web that includes fibers (e.g., staple fibers) that compositionally comprise an elastomer, such as TPU or TPEE. For example, the fiber-web elastomeric layer can be carded and pre-needled prior to being bonded to one or more other fiber webs.

In some examples, the elastomeric layer can include a blend of continuous-length filaments (e.g., sometimes called infinite length) and staple fibers.

The term “composite textile” refers to a fabric that includes two or more different textile or material layers (e.g., a fiber web and a functional layer) that are joined into a material with enhanced properties. The layers can include various types of textiles, including knit, woven, nonwoven, braided, films, and the like. The layers can include coatings, sprays, prints, extrusions, and other depositions. The layers can be joined by various techniques and structures, such as laminating, coating, extrusion, interweaving, interknitting, entanglement (e.g., fluid and/or needle), and the like. In some examples, a composite textile can include one or more constituent layers. A constituent layer is a material layer within the composite textile. In some examples, a constituent layer can include properties or characteristics that are different from other constituent layers, while still existing as a part of the overall composite textile.

The term “color” or “color property” as used herein when referring to the nonwoven textile generally refers to an observable color of fibers that form the textile. Such aspects contemplate that a color may be any color that may be afforded to fibers using dyes, pigments, and/or colorants that are known in the art. As such, fibers may be configured to have a color including, but not limited to red, orange, yellow, green, blue, indigo, violet, white, black, and shades thereof. In one example aspect, the color may be imparted to the fiber when the fiber is formed (commonly known as dope dyeing). In dope dyeing, the color is added to the fiber as it is being extruded such that the color is integral to the fiber and is not added to the fiber in a post-formation step (e.g., through a piece dyeing step).

Aspects related to a color further contemplate determining if one color is different from another color. In these aspects, a color may comprise a numerical color value, which may be determined by using instruments that objectively measure and/or calculate color values of a color of an object by standardizing and/or quantifying factors that may affect a perception of a color. Such instruments include, but are not limited to spectroradiometers, spectrophotometers, and the like. Thus, aspects herein contemplate that a “color” of a textile provided by fibers may comprise a numerical color value that is measured and/or calculated using spectroradiometers and/or spectrophotometers. Moreover, numerical color values may be associated with a color space or color model, which is a specific organization of colors that provides color representations for numerical color values, and thus, each numerical color value corresponds to a singular color represented in the color space or color model.

In these aspects, a color may be determined to be different from another color if a numerical color value of each color differs. Such a determination may be made by measuring and/or calculating a numerical color value of, for instance, a first textile having a first color with a spectroradiometer or a spectrophotometer, measuring and/or calculating a numerical color value of a second textile having a second color with the same instrument (i.e., if a spectrophotometer was used to measure the numerical color value of the first color, then a spectrophotometer is used to measure the numerical color value of the second color), and comparing the numerical color value of the first color with the numerical color value of the second color.

In another example, the determination may be made by measuring and/or calculating a numerical color value of a first area of a textile with a spectroradiometer or a spectrophotometer, measuring and/or calculating a numerical color value of a second area of the textile having a second color with the same instrument, and comparing the numerical color value of the first color with the numerical color value of the second color. If the numerical color values are not equal, then the first color or the first color property is different than the second color or the second color property, and vice versa.

Further, it is also contemplated that a visual distinction between two colors may correlate with a percentage difference between the numerical color values of the first color and the second color, and the visual distinction will be greater as the percentage difference between the color values increases. Moreover, a visual distinction may be based on a comparison between colors representations of the color values in a color space or model. For instance, when a first color has a numerical color value that corresponds to a represented color that is black or navy and a second color has a numerical color value that corresponds to a represented color that is red or yellow, a visual distinction between the first color and the second color is greater than a visual distinction between a first color with a represented color that is red and a second color with a represented color that is yellow.

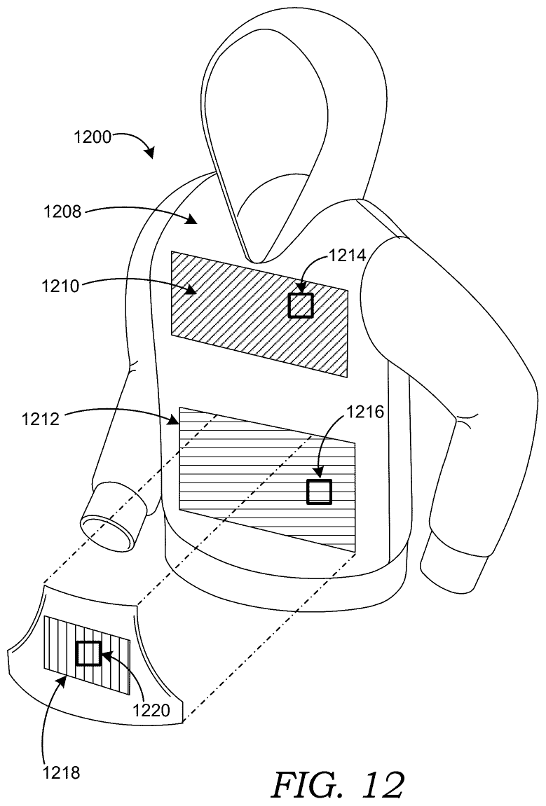

The term “unit area” (e.g., 1214 in FIG. 12) can describe a portion of a textile used to assess properties of the textile. In some examples, a unit area can include a 1 cm×1 cm (1 cm²), although other sizes can be used, as necessary or dictated based on the property to be assessed. In some examples, a “unit volume” can be used to asses properties of a textile, and a unit volume can include a 1 cm×1 cm×n, where n is a depth or thickness associated with the textile. In some examples, n is the entire thickness of the textile or is the thickness of a layer within the textile (e.g., the thickness of a fiber web within the textile). Other dimensions of unit volumes can also be used, as necessary or dictated based on the property to be assessed.

The term “homogeneous,” as used herein, can describe a fiber and can describe a set of fibers and refers to the quality of having relatively uniform properties. The term “homogeneity” refers to the degree to which a fiber or a set of fibers is homogeneous. Homogeneity can be used to describe a fiber or a fiber web at various stages of processing (e.g., entanglement), such as when the fiber or fiber webs are deposited onto a substrate, carded, lapped, pre-needled, entangled with other fiber webs, in a composite nonwoven textile, in a multi-layer pattern piece, in a fiber-web remnant, shredded, re-extruded, and the like. Homogeneity can be based on one or more properties, such as fiber orientation, fiber length, denier, diameter, color properties, shape (e.g., cross-sectional profile), and chemical composition. Homogeneity can be measured in various manners. In one example, homogeneity can be based on measurements applied to a single fiber. In some examples, homogeneity can describe a blend of fibers (e.g., a homogenous blend of fibers). In one example, homogeneity can be based on a unit area or unit volume of a fiber web.

Homogeneity can be measured in various manners, which can depend on what property is being measured. For example, homogeneity can be determined by analyzing the fibers within a unit area or unit volume to measure one or more properties (e.g., orientation, denier, diameter, shape, length, color property, chemical composition, etc.) of the fibers and determining what percentage of fibers include a common property. In some examples, material composition can be based on one or more various known methods of chemical analysis, and homogeneity can be based on what percentage of material within a unit area includes a common chemical composition. Color property can be determined as described in other parts of this disclosure.

In at least some examples, homogeneity (e.g., a degree or relative amount of homogeneity) can be determined based on an average measured parameter in n number of regions of interest (ROI) having a standard deviation equal to, or less than, “X” units of the average value. In some examples, a property can be considered homogenous when the standard deviation is 5.0 or less and can be considered highly homogenous when the standard deviation is 1.0 or less. In at least some examples, can be at least three or more.

For example, if within a textile (e.g., fiber web, composite nonwoven textile, etc.) four ROIs have a basis weight of 84, 87, 87, and 88, then the average basis weight is 86.5 and the standard deviation is 1.73. In examples, in which homogenous is based on a standard deviation of 5.0 or less, the textile can be deemed homogenous based on basis weight. If the basis weights were 84, 85, 85, and 86, then the average basis weight would be 85, the standard deviation would be 0.82, and where a standard deviation of 1.0 or less indicates highly homogenous, then the textile could be deemed highly homogenous with respect to basis weight.

The term “pill” or “pilling” as used herein refers to the formation of small balls of fibers or fibers ends on a facing side of the nonwoven textile. The pill may extend away from a surface plane of the face. Pills are generally formed during normal wash and wear due to forces (e.g., abrasion forces) that cause the fiber ends to migrate through the face of the nonwoven textile and entangle with other fiber ends. A textile's resistance to pilling may be measured using standardized tests such as Random Tumble and Martindale Pilling tests. The term “pile” as used herein generally refers to a raised surface or nap of a textile consisting of upright loops and/or terminal ends of fibers that extend from a face of the textile in a common direction.

Various measurements are provided herein with respect to both the joined layers and the resulting composite nonwoven textile. Thickness of the resulting composite nonwoven may be measured using a precision thickness gauge. To measure thickness, for example, the textile may be positioned on a flat anvil and a pressure foot is pressed on to it from the upper surface under a standard fixed load. A dial indicator on the precision thickness gauge gives an indication of the thickness in mm.

In at least some examples, a textile of the present disclosure can include desired basis weight, which can be assessed via ISO3801 (e.g., method 5) testing standard and has the units grams per square meter (gsm).

In at least some examples, a textile of the present disclosure can include desired textile stiffness, which generally corresponds to drape, and can be assessed using ASTMD4032 (2008) testing standard and has the units kilogram force (Kgf).

Fabric growth and recovery can be measured using ASTM2594 testing standard and is expressed as a percentage.

The term “stretch” as used herein means a textile characteristic measured as an increase of a specified distance under a prescribed tension and is generally expressed as a percentage of the original benchmark distance (i.e., the resting length or width). In at least some examples, a textile of the present disclosure can include desired stretch property, which can be assessed using ASTM D2594 (e.g., loop and 5 lb weight). In some examples, textiles of this disclosure can include a minimum stretch of 20% in the length and 20% in the width. In some examples, the textiles can include a minimum stretch of less than 20% in the length and less than 20% in the width.

The term “growth” as used herein means an increase in distance of a specified benchmark (i.e., the resting length or width) after extension to a prescribed tension for a time interval followed by the release of tension and is usually expressed as a percentage of the original benchmark distance.

“Recovery” as used herein means the ability of a textile to return to its original benchmark distance (i.e., its resting length or width) and is expressed as a percentage of the original benchmark distance. In at least some examples, a textile of the present disclosure can include desired recovery property, which can be assessed using ASTM D2594 (e.g., loop and 5 lb weight). In some examples of this disclosure, the textile can recover, in its length, to at least 110% (e.g., 10% greater than the resting length) within 60 seconds after stretched by 15%. In some examples, the textile can recover, in its length, to at least 105% (e.g., 5% greater than the resting length) within 1 hour after being stretched by 15%. In some examples, the textile can recover, in its width, to at least 120% (e.g., 20% greater than the resting width) within 60 seconds after stretched by 30%. In some examples, the textile can recover, in its width, to 110% (e.g., 10% greater than the resting width) within 1 hour after being stretched by 30%. In examples, the textile can recover to a lesser extent or to a greater extent than these example percentages.

In at least some examples, a textile of the present disclosure can include desired thermal resistance (e.g., generally corresponding to insulation features), which can be measured using ISO11092 testing standard and has the units of RCT (M2*K/W).

Wicking describes the ability of a structure (e.g., fiber, yarn, or textile) to transport liquid (e.g., water, sweat, etc.) from one position or location to another position or location. In some instances, a structure can transport liquid via pores, capillaries, or interstices due to capillary action, surface tension, or other molecular forces. In the context of a textile, wicking can be associated with absorbing moisture that is close to the wearer and transporting the moisture away from the wearer. In at least some examples, wicking can be evaluated based on a horizontal wicking test in which a droplet of water is deposited on the surface of a horizontally laid flat fabric and the rate and extent of spread is measured. In some examples, wicking can be evaluated based on a vertical wicking test, in which a sample is hung vertically and the end of the sample is positioned in a liquid (e.g., water), after which the height to which the liquid is transported can be measured at given time intervals. An example of a test includes AATCC 197.

In at least some examples, a textile of the present disclosure can include desired air permeability, which can be assessed via ASTM D737 (e.g., Max. 200 CFM).

In at least some examples, a textile of the present disclosure can include desired bursting strength, which can be assessed via ASTM D 6797-2015 (e.g., 25 mm Ball Burster, where textile can withstand min. lbf.).

Unless otherwise noted, all measurements provided herein are measured at standard ambient temperature and pressure (25 degrees Celsius or 298.15 K and 1 bar) with the nonwoven textile in a resting (un-stretched) state.

As used herein, the terms “about” and “substantially” mean +/−10% of a given value, such as a linear dimension value (e.g., height, width, etc.) or a weight value. In addition, with respect to an angle or angular dimension, or the terms parallel and perpendicular, the terms “about” and “substantially” mean within 10 degrees. If the “about” or “substantially” is otherwise used, the terms include equivalents of the subject element, where appropriate.

Various examples are described below with reference to the drawings, and the structure, relationship, and/or functioning of examples can, in some instances, be better understood by reference to this detailed description. However, examples associated with the subject matter of this application are not limited to those illustrated in the drawings or explicitly described below. The drawings might not necessarily be to scale. In some instances, for clarity, brevity, and/or simplicity details might have been omitted, which does not preclude the inclusion of those details in association with examples of this disclosure.

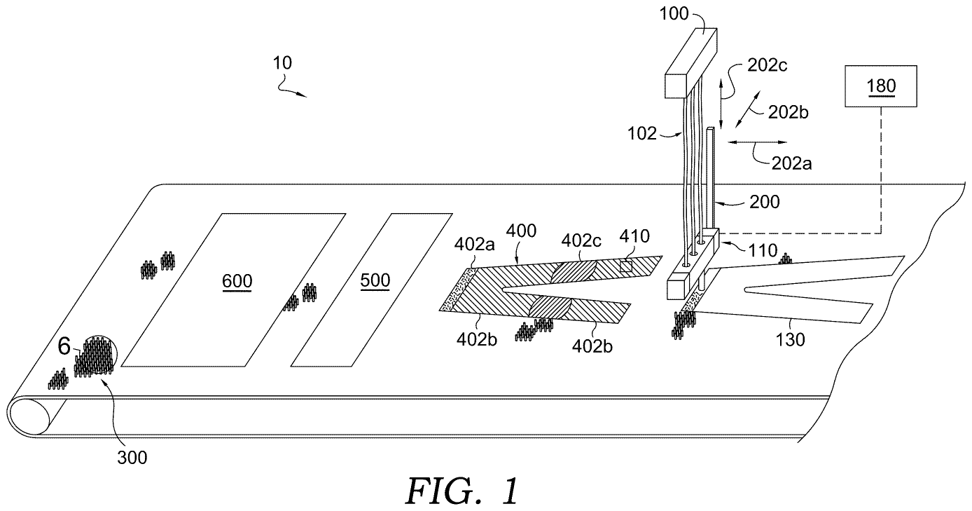

FIG. 1 is a schematic depiction of an operating environment in the manufacture of the nonwoven textile, which can include a composite textile having one or more nonwoven layers. Reference numeral 10 indicates a system for the manufacture of nonwoven textiles. The system 10 generally indicates a fiber source 100 that supplies one or more fiber collections (e.g., sliver, roving, loose fiber, etc.) to a fiber-delivery head 110. In some examples, the fiber-delivery head 110 separates fibers from one another (e.g., teases or otherwise pulls fibers apart from one another) for depositing to a substrate 300.

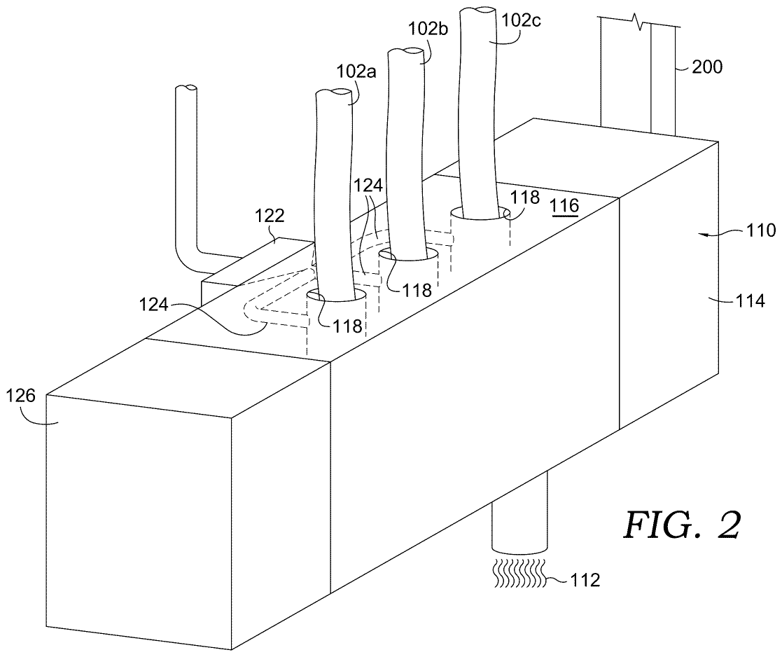

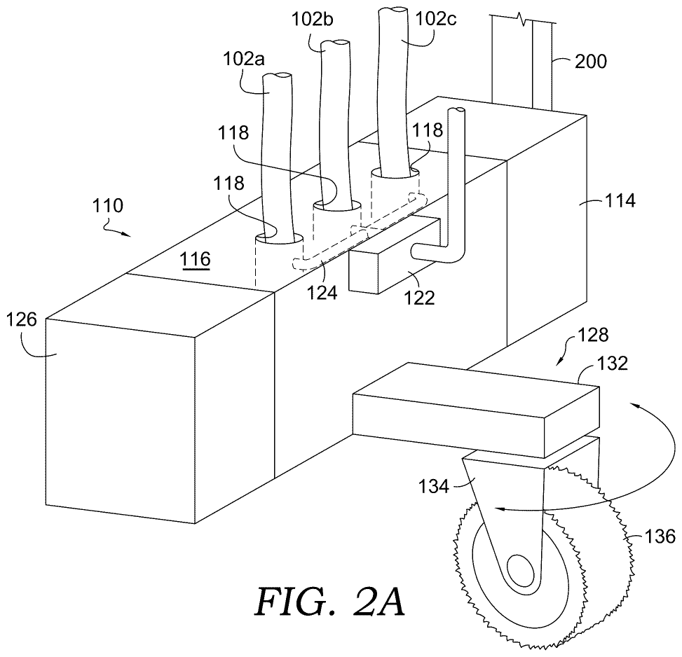

While shown schematically, the fiber source 100 could hold spools, rolls or other bulk fiber bundle material or loose fiber fill. The fiber source 100 can supply individual fiber collections, bundles, or groupings (shown as 102a, 102b and 102c in FIG. 2) to the fiber-delivery head 110, which is described further below. The fiber-delivery head 110 is supported by a gantry 200. While three fibers collections (102a-102c) are depicted in FIG. 2, other numbers of fiber collections are contemplated herein. In some examples, the fiber collections 102a, 102b, and 102c can include sliver or roving. In some examples, the fiber collections 102a, 102b, and 102c can include loose fiber configurations that can be fed from the fiber source 100 to the fiber-delivery head 110.

Examples of this disclosure include a gantry 200 that can be used to position the fiber-delivery head 200 and/or any other tools or components associated with the system 10. As used in this disclosure, a gantry generally includes a framework with an actuator that can traverse along and/or using the framework to position a tool (e.g., fiber-delivery head, entanglement head, laser head, cutting head, spray head, extrusion head, etc.). In some examples, the gantry 200 can include a CNC style gantry, which can include some framework that supports a drive unit that connects directly or indirectly to one or more tools. For example, the drive unit can be attached to a tool mount that can attach to the fiber-delivery head or other tool.

In examples, the gantry 200 is a controllable system operable to move the fiber-delivery head 110 (or other tool) relative to the underlying substrate 300. In some aspects, the gantry 200 is operable to move the fiber-delivery head 110 in an x-direction (shown by arrow 202a) and a y-direction (shown by arrow 202b). Further, in some aspects, the gantry 200 is operable to move the fiber-delivery head 110 in a z-direction (shown by arrow 202c). In some examples, the gantry 200 can adjust an angle of the fiber-delivery head 110 or other tool (e.g., by a hinge, swivel, or other action). The fiber-delivery head 110, as described further below, can separate fibers (shown schematically at 112 in FIG. 2) from one or more of the fiber collections 102 and delivers the fibers 112 onto the substrate 300. In some instances, the fibers in the fiber collections 102 might already be separated, and the fiber-delivery head 110 deposits the fibers onto the substrate (e.g., via a propulsion gas or other propulsion medium).

Because the gantry 200 can move the fiber-delivery head 110 along multiple axes, the fibers 112 can be delivered to the substrate 300 in a pattern 130. The outline of the pattern 130 is shown in FIG. 1 for illustration purposes, and, in some aspects, the pattern 130 would not be visible on the substrate 300. In other aspects, the pattern 130 shown in FIG. 1 may be a thin layer of material or textile, such as a film or web, which can include an extruded material, knit, woven, nonwoven, etc. that further supports the fibers 112 above the substrate 300. In some examples, the pattern 130 can be a two-dimensional pattern. In some examples, the pattern 130 can be a three-dimensional pattern or form onto which fibers can be deposited. For example, in some instances the three-dimensional form can include a footwear last (or other footwear-shaped form), upper-torso bust, or lower-torso form.

In some aspects, the gantry 200 is operable to move the fiber-delivery head 110 above a stationary substrate 300 to deposit the fibers 112 in the pattern 130. In other aspects, the substrate 300 may be moveable in the x-direction 202a (e.g., via a conveyor) and/or in the y-direction 202b as the fiber-delivery head 110 delivers the fibers in the pattern 130. As described further below, the fiber-delivery head 110 can deliver fibers 112 from one or more fiber collections 102 to an area of the substrate below the fiber-delivery head 110. The fiber-delivery head 110 thus allows multiple fiber types from different fiber collections 102 to be simultaneously delivered to a specific area on the pattern 130. Further, in some aspects, the gantry 200 may move the fiber-delivery head 110 in multiple passes over the same area of the pattern 130 to deliver multiple layers of fibers. In this layering process, the gantry 200 may move the fiber-delivery head 110 up and down along the z-axis to position the fiber-delivery head 110 at a desired height above the substrate 300. While only one fiber-delivery head 110 is shown in FIG. 1, it is also contemplated that more than one assembly of a fiber source 100, fiber-delivery head 110 and gantry 200 may be used within the system 10.

In at least some examples, the system 10 can include one or more components for retaining fibers near the substrate. For example, a vacuum can be positioned beneath the substrate 300.

After the fibers 112 are delivered onto the substrate 300, the fibers 112 can be entangled in one or more fiber-entanglement steps (e.g., needle-punching steps, hydro-entanglement steps, etc.). For example, in some instances one or more passes can be made with one or more needle-punch heads or fluid-jet heads (e.g., air jetted, liquid jetted, etc.), which can have various properties (e.g., quantity of needles or jets, density of needles or jets, needle or jet diameter, barb shape, barb direction, etc.), and each pass can apply various densities of stitches. In at least some examples, an entanglement head can be attached to a separate gantry from the fiber-delivery head 110 or be positioned at a separate processing station. In some examples, the fiber-delivery head 110 can be exchanged with an entanglement head (e.g., the fiber-delivery head 110 can be disconnected from the gantry and the entanglement head can be attached). In some examples, the entanglement head and the fiber-delivery head 110 can both be mounted to the gantry at the same time. In at least some examples, the entanglement head can be modular, such that needle boards or jet arrays with different properties can be selectively attached to the entanglement head, depending on the desired entanglement parameters.

In some examples a first pass can be executed with a first needle-punch head having a larger needle board with more needles. In addition, the first pass can apply stitches across a larger area of the fibers 112 deposited on the substrate. In addition, in a subsequent pass, a different needle-punch head with fewer needles can apply stitches in select locations associated with finer details (e.g., pattern piece outlines, interesting aesthetic designs, etc.). In at least some examples, the needle-punch head can include barbed needles, reverse-barb needles, or any combination thereof. In examples, using a reverse-barb needle can allow for unique designs to be created with tailored position(s) using the gantry system (e.g., which can be controlled via CNC). In addition, a reverse-barb needle technique can be used without needing to flip the textile over.

In another example, a first pass with less needling/stitches can be executed in select areas (e.g., as opposed to larger area of the fibers 112) to impart an initial amount of entanglement, and a subsequent pass can then entangle a larger area of the fibers (e.g., a first pre-needling process with a needle-punch head having fewer needles or with a needle-punch head having less needles per square inch, followed by a needle-punch head having more needles or with a needle-punch head having more needles per square inch), creating a nonwoven textile 400.

In some examples, one or more passes can include using reverse barb needles to pull fibers that are positioned closer to the substrate 300 to the outer face of the textile. For example, multiple fiber layers can be deposited onto the substrate 300, such that a fiber layer closer to the substate 300 includes fibers with a different color than fibers farther from the substrate (and closer to the entanglement head). Using reverse barbs, the fibers with the different color can be pulled through the one or more other layers to an outer face of the layers, and since the gantry 200 is programmable, a design (e.g., logo other shape) can be created.

The nonwoven textile 400 may also be subjected to other processes (e.g., after being deposited on the substrate and/or after being entangled). In some aspects, these other processes may include, but are not limited to thermal bonding (shown schematically at 500) or chemical bonding (shown schematically at 600). As used herein, the term “chemical bonding” refers to the use of chemical binders (e.g., adhesive materials) that are used to hold fibers together. The chemical binder joins fibers together at fiber intersections and fiber bonding results. Chemical binder can be applied using various techniques, such as spraying, printing, brushing, rolling, etc. As used herein, the term “thermal bonding” refers to a process that may include locally heating fibers to melt, partially melt, and/or soften the fibers. Energy for heating can be applied in various manners, such as with an ultrasonic head, laser head, and the like.

The nonwoven textile 400 may be formed in the shape of a pattern (e.g. pattern 130) usable in creating an article of apparel. While the pattern 130 is shown in a shape usable in a lower-body garment, other shapes could also be used. In forming the nonwoven textile 400 in a usable pattern shape, an article of apparel using the nonwoven textile 400 may result in less wasted material and in a more-efficient process, as compared to creating sheets of nonwoven textiles from which patterns are cut. Because the step of cutting a pattern shape from a sheet of nonwoven textile is unnecessary, or if cutting or trimming is performed, it may result is less remnant material around the periphery of the pattern shape.

The fiber-delivery head 110 and the gantry 200 also enable the formation of areas, within the nonwoven textile 400, having different zonal properties. In some aspects, different properties may be formed within the nonwoven textile 400 based on the direction of movement of the fiber-delivery head 110 as it is delivering the fibers 112 to the substrate 300. The movement of the fiber-delivery head 110 provides some degree of overall fiber orientation in that area of the nonwoven textile 400. For example, as the fiber-delivery head 110 traverses across a given portion of pattern or panel or other form of textile, the fibers 112 might generally be aligned in the direction of movement of the fiber-delivery head. In some examples, the fiber-deliver head 110 is controlled in such a manner as to traverse in a given direction, and once a pass has been completed from a first point (e.g., a first side of the pattern) to a second point (e.g., an opposing second side of the pattern), the fiber-delivery head is incrementally moved adjacent to the first pass in order to complete a second pass. In that case, the fibers laid down in the first pass can include a similar orientation as the fibers laid down in the second pass, with the fibers in the second pass being adjacent (e.g., positioned slightly adjacent in the x-y plane).

Further, in some aspects, the fiber-delivery head 110 can selectively deposit fibers 112 from one or more of the fiber collections 102a, 102b, and 102c (e.g., sliver, roving, or other loose collection of fibers), which can include fibers having different fiber properties. The selective deposition of fibers from one or more of the fiber collections 102-102c, combined with the movement of the gantry 200, can contribute to the formation of the nonwoven textile 400 having zonal properties. The fiber-delivery head 110 can deposit fibers from a single fiber collections. In some examples, the fiber-deliver head can deposit a mixture of fibers 112 from two or more fiber collections 102 of different materials. The selection of the fiber collection 102 (e.g., from among the fiber collections 102a-102c) can be based on the desired end properties of the nonwoven textile 400, such as basis weight, breathability, stretch and recovery, color, hand feel, drapability, moisture management, and on one or more fiber properties, such as fiber denier, fiber cross-sectional shape, fiber compositional material, fiber length, fiber color, wicking ability, and fiber coating. The selection is based on desired end properties of the nonwoven textile 400.

As one example, the nonwoven textile 400 shown in FIG. 1 may be formed with a first zone 402a, a second zone 402b, and a third zone 402c. The zones 402a, 402b and 402c are depicted for context, and many other zone locations, sizes and shapes could be present on the pattern 130. Each zone may comprise different textile properties (e.g. fiber material, elasticity, number of layers, thickness, durability, drapability, feel, basis weight, abrasion resistance, pilling resistance, color, thermal resistance, water resistance, water repellency, breathability, etc.). The gantry 200 and the fiber-delivery head 110 deliver fibers 112 to each zone from a selected fiber collection or fiber collections based upon the desired end properties for the zone.

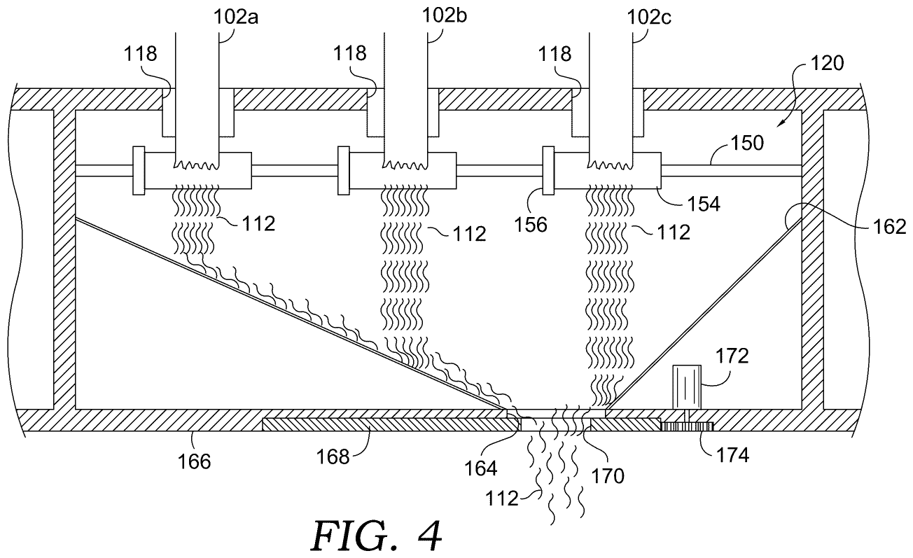

FIG. 2 is an enlarged depiction of the fiber-delivery head 110, showing a partial view of the gantry 200, and individual fiber collections 102a, 102b and 102c. In some aspects, the fiber-delivery head 110 includes a power and control module 114. In some aspects, the module 114 is coupled to the gantry 200 and receives power from the gantry 200. The module 114 may provide instructions to other components of the fiber-delivery head 110, as further described below. As shown in FIG. 1, a control panel 180 may be coupled to the power and control module 114 on the fiber-delivery head 110. The control panel 180 may, among other things, display the status of the gantry 200 and the fiber-delivery head 110, and allow instructions to input and delivered to the power and control module 114 on the fiber-delivery head 110. As shown in FIG. 2, the fiber-delivery head 110 includes a top plate 116 with ports 118. The fiber collections 102 are fed through a corresponding port 118. As best seen in FIG. 4, each port 118 may extend into an interior chamber 120 of the fiber-delivery head 110. The fiber-delivery head 110 may also include, in some aspects, a manifold 122 coupled to a fluid source (e.g. compressed air). In some aspects, the manifold can selectively deliver compressed air to one or more of the ports 118 through outlet lines 124. In other aspects, the manifold delivers compressed air simultaneously to the ports 118. The delivered fluid operates to move the fibers through the fiber delivery head, and also aides in further separating the fibers. In some aspects, the fiber-delivery head 110 may also include an integrated processing module 126. The processing module 126 can be, in some aspects, an interchangeable component. In some aspects, the processing module 126 can be a needle-punch head, a fluid-entanglement head, a laser-emitting head (e.g., for thermal bonding, cutting, etc.), a heating element, another type of fiber deposition head (e.g., fiber spray head, meltblown head, spunbond head, etc.), ink-jet head, embroidery head, or a chemical delivery head (e.g., spray nozzle, printer, etc.). Further, in some aspects, the fiber-delivery head 110 may include a series of processing modules 126 (e.g. a first needle-punch head with a first number of needles, and a second needle-punch head with a second number of needles). The fiber-delivery head 110 may also include, in some aspects, an integrated roller 128 to compress the fibers 112 delivered to the substrate 300. The roller 128 may be fixed to the fiber-delivery head 110 via a beam 132 that supports a swivel caster 134 having a wheel 136. In some aspects, the wheel 136 has an outer texture to engage and compress the fibers 112 on the substrate 300.

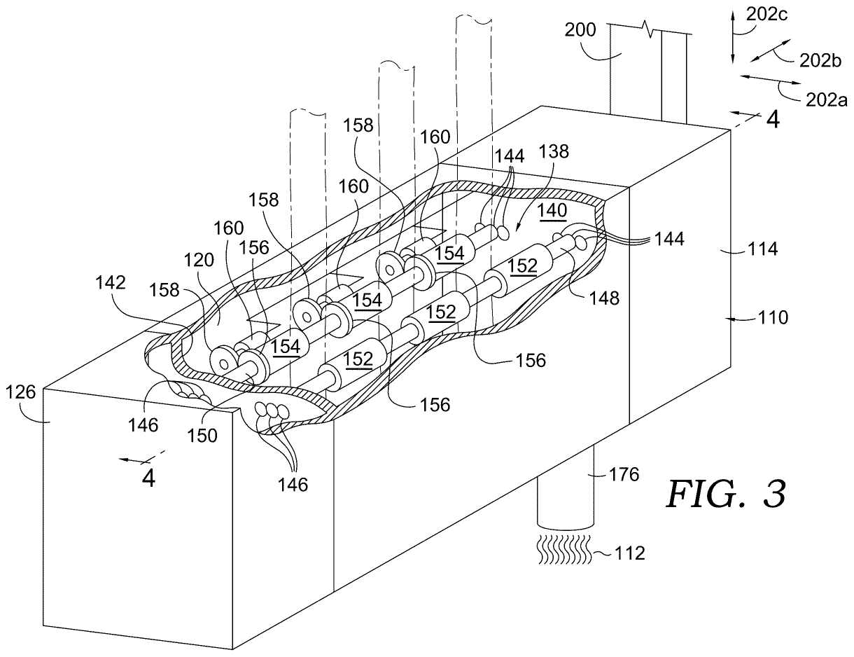

As seen in FIG. 3, a portion of the top plate 116 is broken away to reveal certain internal components of the fiber-delivery head 110. As seen in FIG. 3, the fiber-delivery head 110 includes a fiber-separator system 138 that separates fibers 112 from a corresponding fiber collection 102. The fibers 112 can include any one or more of the fibers described in this specification. In some aspects, the interior chamber 120 is defined, at least in part, by a first side wall 140 spaced apart from a second side wall 142. Each side wall 140, 142 may include a series of spaced mounting holes 144 and 146. The mounting holes 144 and 146 support a first roller shaft 148 and a second roller shaft 150. In some aspects, the first roller shaft 148 includes a series of rollers 152 spaced along the shaft 148 in locations corresponding to the ports 118 for the fiber collections 102. In some aspects, the rollers 152 are idler rollers that freely rotate, but are not powered. The second roller shaft 150 also includes, in some aspects, a series of rollers 154 spaced along the shaft 150 in locations corresponding to the ports 118 for the fiber collections 102 (and corresponding to the locations of the rollers 152). In some aspects, the first shaft 148 and the second shaft 150 are spaced apart a distance based on the mounting holes 144 and 146 in which the corresponding shaft is located. By changing the distance between the first shaft 148 and the second shaft 150 (and thus the distance between the rollers 152 and 154), the fiber-delivery head 110 can accommodate fiber collections 102 of different diameters. In some aspects, the rollers 154 are coupled to a gear 156 that is also coupled to the shaft 150. In some aspects, the gear 156 is driven by a corresponding gear 158 that is in turn driven by a motor 160. By engaging the motor 160, the gear 158 interacts with the gear 156 to rotate the roller 154 on the shaft 150. While not shown, the surfaces of the rollers 152 and/or the surfaces of the rollers 154 may be textured to engage the fiber collections 102 and separate fibers 112 from the fiber collections 102. Fibers 112 from a selected fiber collection 102, or fibers from two or more fiber collections 102, may be separated by controlling the motors 160. In this way, the fiber-delivery head 110 can deliver fibers 112 from a selected one of the fiber collections 102, or a combination of fibers 112 from a plurality of fiber collections 102, at a desired location on the pattern 130. Further, while not shown, the rollers 152 may also be driven by a motor arrangement similar to that described above with respect to the rollers 154.

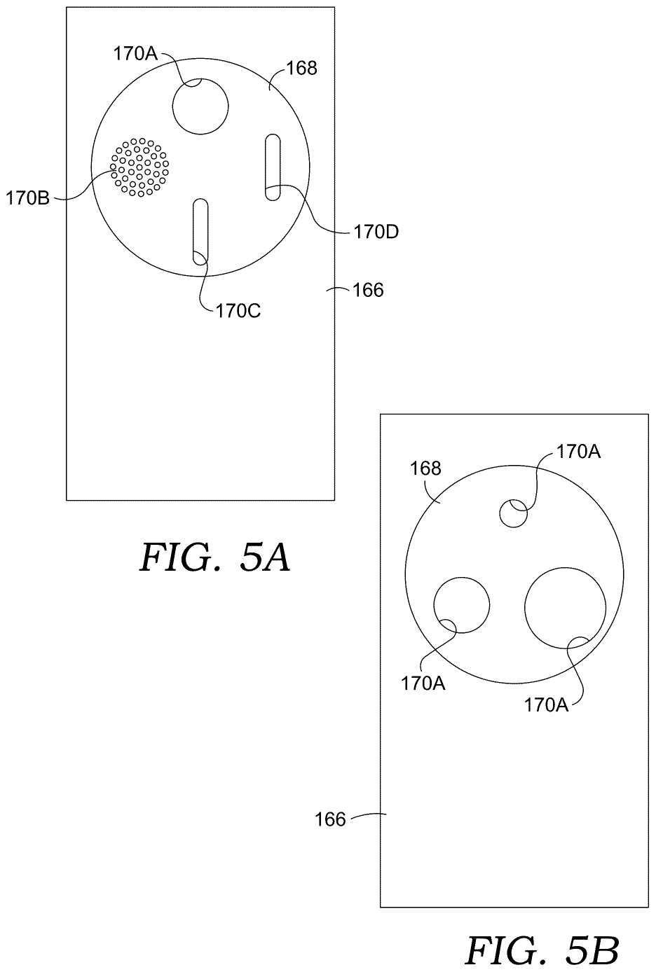

As seen in FIG. 4, the interior chamber 120 of the fiber-delivery head 110 may include, in some aspects, interior walls defining a chute 162 that directs the separated fibers 112 to an outlet 164. As seen in FIGS. 4, 5a and 5B, the chute 162 may direct the fibers 112 to the outlet 164 directly above a bottom plate 166. In some aspects, the bottom plate 166 includes a nozzle face 168 having a number of different shapes, sizes and/or configurations of nozzles 170. The nozzle face 168 is rotatable with respect to the bottom plate 166, such that a selected one of the nozzles 170 is positioned below the outlet 164. By varying the nozzle 170 below the outlet 164, the distribution or spray pattern of the fibers 112 onto the substrate 130 can be adjusted. FIG. 5A depicts a circular nozzle 170A, a shower configuration nozzle 170B, a horizontal fan nozzle 170C and a vertical fan nozzle 170D. FIG. 5B depicts circular nozzles 170A having different diameters. Other shapes, configurations, and sizes for the nozzle 170 could also be used. Further, in some aspects, an individual nozzle could be coupled to the fiber-delivery head 110, such as with a threaded connection, and these individual nozzles could be interchanged as desired. As shown in FIG. 4, the nozzle face 168 may be rotated (as controlled by the power and control module 114) by a motor 172 coupled to a gear 174. The gear 174 interacts with teeth on the outer diameter of the nozzle face 168 to rotate a desired one of the nozzles 170 in place below the outlet 164. In some aspects, as shown in FIG. 3, the fiber-delivery head 110 may also include a tube 176 located below the outlet 164. The tube 176 could be used in place of, or in addition to, the nozzle face 168.

Based on the desired properties at a specific location on the pattern 130, the gantry 200 moves the fiber-delivery head 110 along a path to provide a desired orientation to the fibers 112. Further, in some aspects, the speed at which the gantry 200 moves the fiber-delivery head 110 may be adjusted to alter the properties at a zone on the pattern (such as the thickness of the layer of fibers 112). The properties within the zone can also be adjusted based on the selected fiber collection(s) (and thus the properties of the separated fibers 112) and/or based on the composition or mixture of fibers 112 from two or more different fiber collections 102.

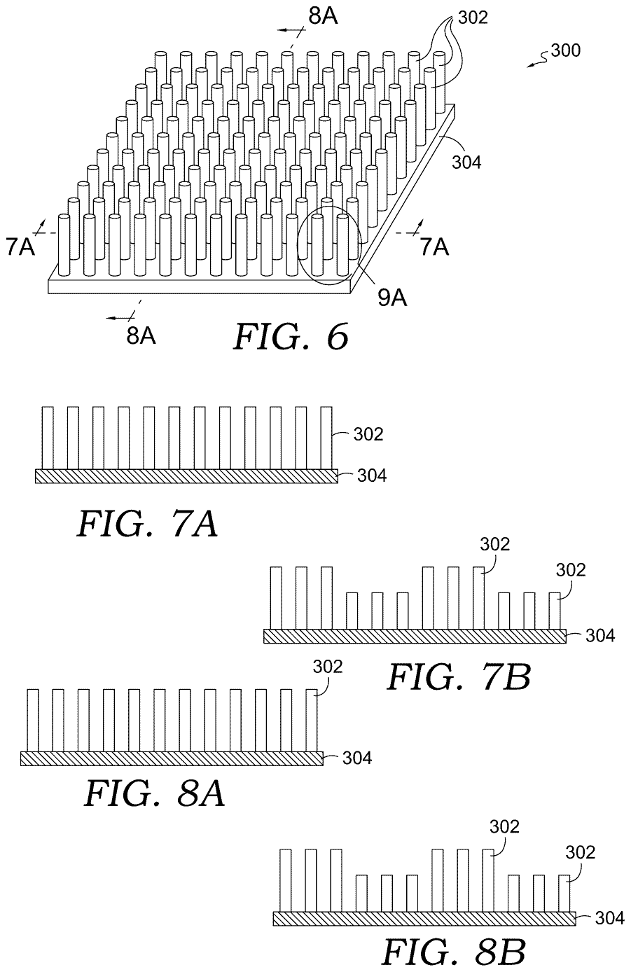

As seen in FIG. 1, the substrate 300 may be in the form of a belt for a conveyor. In other aspects, the substrate 300 may be in the form of a stationary grid or panel, with only the fiber-delivery head 110 moving with respect to the substrate 300. An enlarged, partial view of the substrate 300 is shown in FIG. 6. As seen in FIG. 6, the substrate 300 may be formed by spaced, upright individual bristles 302 held within a base 304.

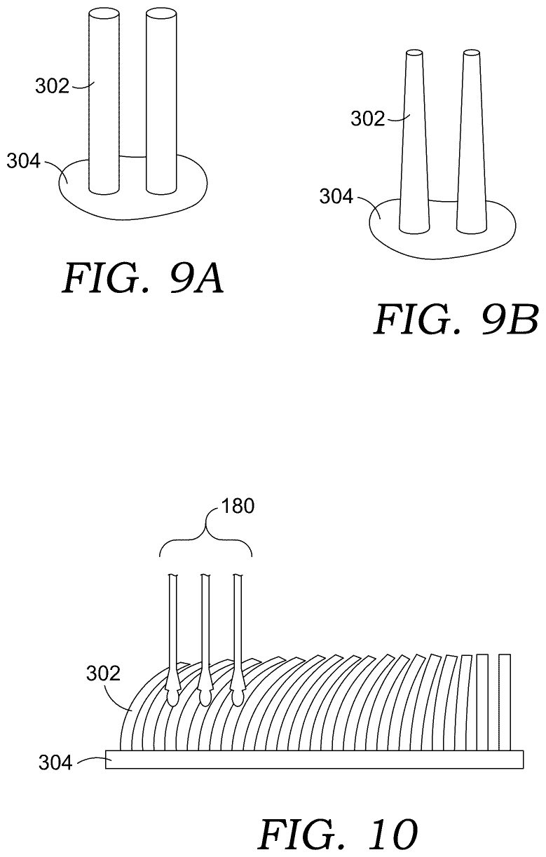

As shown in FIG. 7A, the bristles 302 may be of a consistent height along the length of the substrate 300. In some aspects, the bristles 302 have a height of between about 15-25 millimeters, or about 18-22 millimeters. In other aspects, as shown in FIG. 7B, the bristles 302 may vary in height along the length of the substrate 300, with some bristles 302 being longer than other bristles 302. As shown in FIG. 7B, the bristles may vary in height according to a pattern. Similarly, as shown in FIG. 8A, the bristles 302 may be of a consistent height along the width of the substrate 300. In other aspects, as shown in FIG. 8B, the bristles 302 may vary in height along with width of the substrate 300, with some bristles 302 being longer than other bristles 302. As shown in FIG. 8B, the bristles 302 may vary in height according to a pattern. In some aspects, the bristles 302 may form a waffle pattern or a grid pattern across the area of the substrate 300. As shown in FIG. 9A, the bristles 302 may be cylindrical in shape, with a constant diameter from the bottom of the bristle 302 to the top of the bristle 302. In some aspects, the diameter of bristles 302 is between about 1.5-2.5 millimeters, and in some aspects, the diameter of the bristles 302 is about 2 millimeters. In other aspects, as shown in FIG. 9B, the bristles 302 may have a smaller diameter at the top of the bristle 302 as compared to a larger diameter at the bottom of the bristle 302. Other shapes could also be used for the bristles 302.

The bristles 302 comprise a resilient material, allowing the bristles to bend in response to a force, but to respond to vertical orientation when the force is removed. In some examples, the bristles 302 can compositionally include a fast recovery elastomeric material. Examples of materials that can form the bristles 302 include silicone (e.g., silicone rubber) or a thermoplastic polymer, such as thermoplastic polyurethane (TPU). In at least some examples, the material can include a shore hardness in a range of 70 A to 80 A.

After the fibers 112 have been delivered to the substrate 300, the fibers 112 rest, at least partially, on top of the bristles 302, with the bristles 302 supporting the fibers 112. After the fibers have been delivered, the processing module 126 (e.g., a needle-punching head) may be engaged to entangle the fibers 112 together and with other layers that may be present (such as previously delivered and entangled fibers, or another layer (e.g., another fiber layer, a meltblown, a spunbond, a knit, a weave, a film layer)). FIG. 10 schematically depicts a representative, partial drawing of needles 180 in a lowered position (below the top of the bristles 302). During this needle-punching, it is possible the gantry 200 may be moving the fiber-delivery head 110, and with it, any needles 180 on the processing module 126. FIG. 10 depicts the resilient bristles 302 bending (on the left-hand side of FIG. 10), in response to this movement. The resiliency of the bristles 302 enhances the likelihood that the needles 180 will remain intact (the needles 180 are less-likely to break).

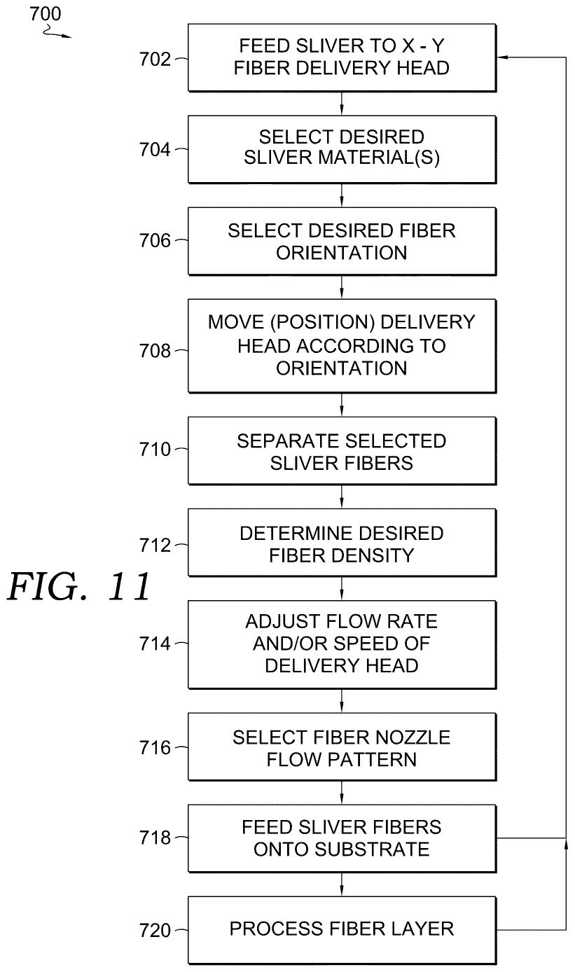

FIG. 11 illustrates an example manufacturing process, referenced generally by the numeral 700, for use in making the example composite nonwoven textile 400. The depiction of the manufacturing components in FIG. 11 is illustrative only and is meant to convey general features of the manufacturing process 700. One or more of the operations described with respect to FIG. 11 can be omitted. In addition, operations described with respect to FIG. 11 can be carried out in a different order. In addition, one or more operations can be added to the operations described with respect to FIG. 11.

The process shown in FIG. 11 includes, as shown at 702, feeding at least one fiber collection (e.g. sliver, roving, or fiber fill) to a fiber-delivery head (e.g. fiber-delivery head 110). As shown in FIG. 11, the fiber-delivery head 110 is moveable (e.g. via the gantry 200) in an x-y plane. As described above, in some aspects, the fiber-delivery head is also moveable vertically in the z-direction and/or can be angularly adjusted. The process 700 continues at 704 by selecting the desired material (e.g. selecting one or more of fiber collections 102a, 102b or 102c) at a location on the pattern 130. The process 700 also includes, as shown at 706, selecting a desired fiber orientation (e.g. the orientation of fibers 112 on the substrate 300). The process 700 continues by moving or positioning the fiber-delivery head based on the desired orientation, as shown at 708. In some aspects, at 708, the gantry 200 is used to move the fiber-delivery head 110 to a position and in a direction based on the desired fiber orientation. At the desired position on the pattern 130, the process 700 continues by separating fibers from the selected fiber collection(s) (e.g. separating fibers 112 from one or more of the fiber collections 102a, 102b or 102c). At the desired position, the process 700 also includes determining a desired fiber density, as shown at 710. The fiber density could be a number of fibers per square inch, or could be expressed as a desired thickness of the fiber layer. Based on the fiber density, as shown at 712, the flow rate of the selected fiber collections through the fiber separator system (e.g. fiber separator system 138) can be adjusted, and/or the speed of the fiber-delivery head can be adjusted (e.g. by adjusting the rate of travel of the gantry 200). In some aspects, the process 700 includes, as shown at 714, selecting a flow pattern or fiber nozzle (e.g., selecting one of the nozzles 170). The process then, at 716, feeds the fibers separated from the selected sliver(s) onto the substrate. As shown at 718, the process 700, in some aspects, also includes processing the fiber layer (e.g. by needle-punching, laser cutting, thermal bonding and/or chemical bonding).

The process 700 allows the manufacture of a nonwoven textile 400 in a pattern 130 usable in an article of apparel. Because the nonwoven textile 400 is in the shape of a usable pattern, the process 700 results in less waste material (as compared to cutting a pattern from a sheet of nonwoven textile material). The process 700 also allows the nonwoven textile 400 to have areas of different zonal properties, based on the end use of the nonwoven textile 400 within an article of apparel either through the composition of the mixture of fibers 112 having different properties (fibers 112 from different slivers 102 at the same zone), the direction of movement of the fiber-delivery head 110 above the substrate 300, the speed at which the fiber-delivery head 110 moves and/or the rate at which the sliver(s) are fed into the fiber-delivery head 110 (as determined by the speed of the rollers 154 in the fiber-separator system 138).

The examples described with respect to the system 10 and the gantry 200 are not exhaustive. In at least some examples, the system 10 includes the gantry 200 that can operate to move the fiber-delivery head 110 and/or a variety of other tools in the x-direction 202a , the y-direction 202b , the z-direction 202c, angularly, and any combination thereof. The gantry 200 can include any combination of arms, slides/ways, spindles, drive units, articulations, joints, pivots, and the like to effect multi-axial movement, movement in the x, y, and z directions, and the like (e.g., six-axis movement, motion, or adjustment of the tool). The gantry 200 can include one or more tool holders for securing the fiber-delivery head 110, entanglement head(s) (e.g., needle or fluid), print head(s), spray head(s, embroidery head(s), extrusion head(s), laser(s), cutting head(s), 3D printer head(s), curing head(s), fused filament head(s), or any other tool(s) described in this disclosure. One or more tools can be simultaneously attached to the gantry, and/or tools can be modular and selectively attached to the gantry and exchanged. In at least some examples, the present solution includes using the gantry to deposit fibers onto a 2D or 3D shape or form. The fibers can be blown in a fluid stream or otherwise sprayed. In some instances the fibers are deposited onto a substrate layered on the shape or form. In other instances, the fibers are deposited directly on the shape or form, such that the fibers form a base layer. The fibers that have been deposited can then be treated using any one or more of the tool or treatment methods described, including (but not limited to), entanglement, printing, thermal bonding, chemical bonding, layering, embroidering, and the like.

At least some examples of the present disclosure are related to a composite textile having zonal properties, and the composite textile can include a pattern piece for a wearable article or the fashioned/assembled wearable article. Referring FIG. 12, an example of a wearable article 1200 is depicted, including an upper-torso garment (e.g., sweatshirt or hoodie), and the present disclosure can include a variety of different other types of wearable articles (e.g., lower-torso garment, footwear, etc.). The wearable article 1200 includes a pattern piece 1208 having a first zone 1210 and a second zone 1212. In at least some examples, the first zone 1210 includes a first unit volume 1214 with a first set of fiber properties and a first set of textile properties. In addition, the second zone 1212 includes a second unit volume 1216 with a second set of fiber properties, which can be different from the first set of fiber properties, and a second set of textile properties, which can be different from the first set of textile properties. The wearable article 1200 can include one or more other pattern pieces with other zones, such as the third pattern piece 1218 with the third zone 1220, which can also have different fiber and textile properties.

One or more various properties (e.g., textile properties and/or fiber properties) can be different as between the unit volumes 1214, 1216, and/or 1220. In at least some examples, the textile properties can include one or more of a basis weight, stretch properties, breathability, thermal resistance properties, pilling properties, abrasion resistance properties, color, drapability, hand feel or softness, water resistance, water repellency, hydrophobicity, hydrophilicity, and the like. The textile properties of a zone or a unit volume can be impacted, at least in part, by the fibers or fiber webs that are deposited in the zone, and two zones having different properties can have fibers and/or fiber webs with different properties. Examples of fiber properties that can vary as between zones can include fiber compositional material, denier, diameter, length, cross-sectional shape, finish, wicking ability, color, orientation, and the like. In at least some examples, differences among different zones can be impacted by entanglement parameters, such as stitch density, entanglement direction (e.g., via forward barb needles or alternatively via reverse barb needles), and needle penetration depth.

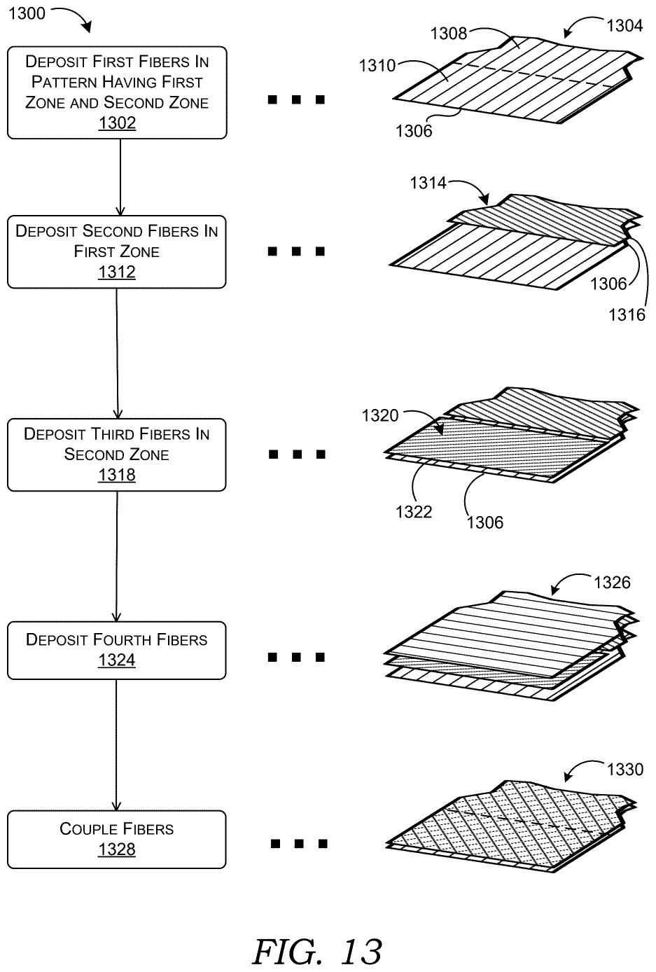

In some examples, a gantry system, such as the system 10, can be used to selectively deposit fibers (e.g., any fibers described in this disclosure) in a given zone to contribute to the zonal properties (e.g., to tailor or customize the properties of a given zone). For example, referring to FIG. 13, a flow diagram is depicted of a method 1300 for constructing a composite textile, and FIG. 13 also includes pictorial representations associated with the steps.

In examples, operation 1302 can include depositing first fibers 1304. The first fibers can be deposited in a shape (e.g., 2D shape or 3D shape) that is associated a perimeter edge or boundary 1306 that defines the shape. In some instances, the shape can be associated with a shape of a pattern piece for a wearable article (e.g., a pattern for a front of an upper-torso garment, a sleeve, a back, a hood, a gusset, a pocket, a footwear upper, etc.). For example, the shape associated with the first fibers 1304 can correspond with a shape for the pattern piece 1208 in FIG. 12 (e.g., a front panel of an upper-torso garment). In examples, an ability of the gantry system to move in the x-y orientation contributes to the deposit of the first fibers 1304 in the pattern having the shape.

The first fibers 1304 and/or the shape in which the first fibers 1304 are arranged can include one or more zones. In at least some examples, the zones can be based on areas associated with the pattern piece (e.g., 1208) that will be used to construct a wearable article. For example, the first fibers 1304 as deposited can be associated with a first zone 1308, which generally corresponds with an upper or more superior portion of the pattern piece when incorporated into a wearable article, and a second zone 1310, which generally corresponds with a lower or more inferior portion of the pattern piece when incorporated into a wearable article.

In at least some examples, operation 1312 includes depositing second fibers 1314 onto the first fibers 1304 and in an area associated with the first zone 1308. In examples, the second fibers 1314 can be deposited in a shape (e.g., 2D shape or 3D shape) that is associated a perimeter edge or boundary 1316 that defines the shape, and at least a portion or segment of the perimeter edge 1316 can correspond with and/or be aligned with (e.g., aligned in the z-direction with) the perimeter edge 1306.

In some examples, the second fibers 1314 can be omitted entirely from the second zone 1310. In some examples, some of the second fibers 1314 can be deposited in a portion of the second zone, and at least some of the second zone 1310 is still free of any of the second fibers 1314.

The second fibers 1314 include fiber properties, including compositional material, denier, diameter, length, cross-sectional shape, finish, wicking ability, color, orientation, and the like. In some examples, the fibers included in the second fibers 1314 can include a consistent set of fiber properties. In some examples, the fibers included in the second fibers 1314 can include a blend of fibers having different fiber properties.

In at least some examples, operation 1318 includes depositing third fibers 1320 onto the first fibers 1304 and in an area associated with the second zone 1310. In examples, the third fibers 1320 can be deposited in a shape (e.g., 2D shape or 3D shape) that is associated a perimeter edge or boundary 1322 that defines the shape, and at least a portion or segment of the perimeter edge 1322 can correspond with and/or be aligned with the perimeter edge 1306.

The third fibers 1320 include fiber properties, one or more of which are different from the second fibers 1314, including one or more of compositional material, denier, diameter, length, cross-sectional shape, finish, wicking ability, color, orientation, and the like. In some examples, the fibers included in the third fibers 1320 can include a consistent set of fiber properties. In some examples, the fibers included in the third fibers 1320 can include a blend of fibers having different fiber properties.

In at least some examples, operation 1324 includes depositing fourth fibers 1326 onto the second fibers 1314 and the third fibers 1320. The fourth fibers 1326 include fiber properties, including one or more of compositional material, denier, diameter, length, cross-sectional shape, finish, wicking ability, color, orientation, and the like. In some examples, the fibers included in the fourth fibers 1326 can include a consistent set of fiber properties. In some examples, the fibers included in the fourth fibers 1326 can include a blend of fibers having different fiber properties.

Operation 1328 can include connecting the fibers 1304, 1314, 1320, and 1326, such as by mechanically entangling. For example, the fibers 1304, 1314, 1320, and 1326 can be needle punched at one or more various stages of the method 1300. The fibers can be needled (e.g., pre-needled) when initially deposited, and one or more of the sets of fibers can be needled to entangle the fibers. The fibers can be entangled by one or more needle-punch heads having needle boards with various properties (e.g., needle quantity, needle density, needle stroke length, barb direction, etc.) and various individual needle properties. Other treatments can also or alternatively be performed, such as hydro-entangling, laser bonding, laminating, thermal bonding, chemical bonding, sonic welding, embroidering, and the like. In examples, connecting the fibers 1304, 1314, 1320, and 1326 can produce a composite textile 1330.

In some instances, one or more of the operations 1302, 1312, 1318, 1320, and 1324 can be carried out via a gantry system, such as the system 10, in which fibers or filaments can be deposited in the pattern associated with (e.g., programmatically instructed or specified) a pattern piece or a zone. In some instances, the fibers 1304, 1314, 1320, and 1326 can include shorter lengths, such as staple fibers having a length between about 30 mm and 110 mm. In some instances, the fibers 1304, 1314, 1320, and 1326 can include longer filaments that are deposited via a spundbond head or a meltblown head (e.g., integrated into the gantry system) or other fiber deposition head. Although not depicted, in some examples, additional operations can be executed with respect to the fibers 1304, 1314, 1320, and 1326 (e.g., in between operations), such as light needling, rolling, laser bonding, chemical bonding, thermal bonding, and the like.

In some examples, one or more of the first fibers 1304 and the fourth fibers 1326 can be omitted.

In at least some examples, the various portions of the composite textile 1330 that are coupled to one another can be integrally formed based on the omission of seams joining two separate pattern pieces.

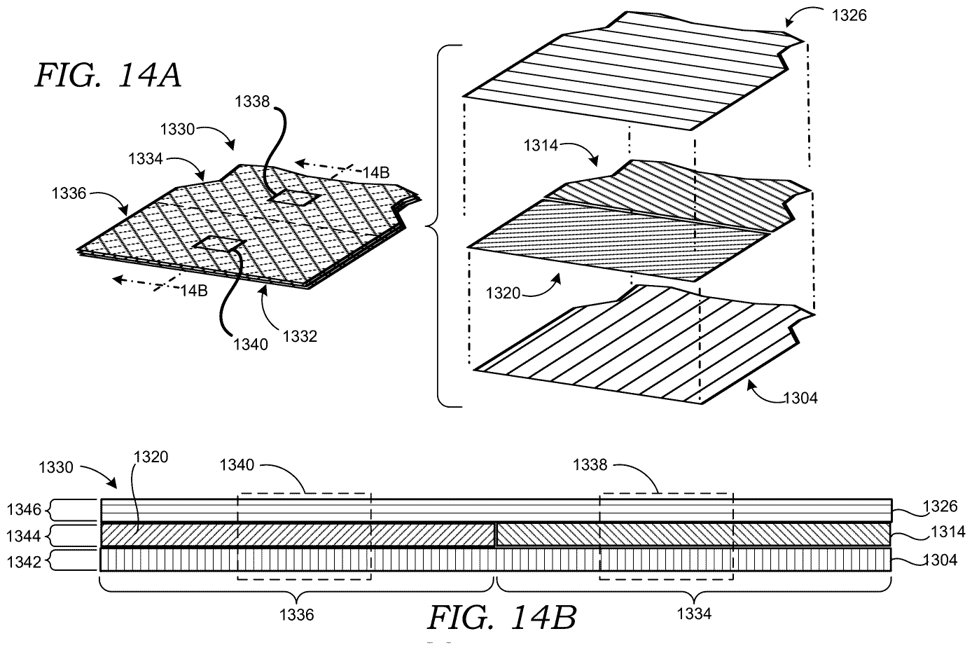

Referring to FIGS. 14A and 14B, the composite textile 1330 is depicted in more detail. The composite textile 1330 includes a perimeter edge or boundary 1332 and a shape of the composite textile (e.g., 2D shape or profile or 3D shape) is defined or formed by the perimeter edge 1332. In some examples, the composite textile 1330 is a pattern piece (e.g., 1208) for a wearable article (e.g., 1200) and the perimeter edge 1332 defines a shape of the pattern piece. In addition, the perimeter edge 1332 can, in some cases, be coupled to other pattern pieces or trims (e.g., at seams) to form the wearable article.

The composite textile 1330 can include a plurality of layers of fibers. For example, as depicted in FIG. 14B, the composite textile 1330 includes three layers of fibers 1342, 1344, and 1346. In some examples, a layer can be associated with a fiber web (e.g., a pre-needled fiber web) or with a set of fibers deposited by a gantry system (e.g., by a delivery head, spunbond head, meltblown head, spunlace head, or other fiber deposition had) as part of a discrete stratum or thickness within the textile.

The composite textile can include the fibers 1304, 1314, 1320, and 1326, which as explained with respect to FIG. 13, can be entangled (e.g., via needle entanglement or fluid entanglement) or otherwise coupled. For example, at least some of the first fibers can 1304 can be entangled with at least some fibers of the second fibers 1314, at least some fibers of the third fibers 1320, and at least some fibers of the fourth fibers 1326. Likewise, at least some fibers of the fourth fibers can be entangled with at least some fibers of the second fibers 1314 and at least some fibers of the third fibers 1320. In some examples, at least one of the first fibers 1304 and the second fibers 1326 can be omitted. In examples, a layer might still be identifiable after the fibers from one layer are entangled with fibers from another layer. For example, in some instances, by examining a cross section, the layers can be viewed. In addition, in some examples, the layers can be pulled part (e.g., by teasing apart along an edge) to identify different layers. Although the cross section of FIG. 14B depicts the layers and zones as discrete portions, it is understood that in some examples, fibers can extend through, and be entangled among, multiple of the layers and zones.

The composite textile can include a first zone 1334 (e.g., corresponding with the first zone 1308) and a second zone 1336 (e.g., corresponding with the second zone 1310). In at least some examples, the first zone 1334 includes a first unit volume 1338 with a first set of fiber properties and a first set of textile properties. In addition, the second zone 1336 includes a second unit volume 1340 with a second set of fiber properties, which can be different from the first set of fiber properties, and a second set of textile properties, which can be different from the first set of textile properties.

In at least some examples, the differences in properties as between the first unit volume and the second unit volume 1340 can be based, at least in part on, the difference(s) in fiber properties as between the second fibers 1314 and the third fibers 1320. Examples of fiber properties that can vary as between zones can include fiber compositional material, denier, diameter, length, cross-sectional shape, finish, wicking ability, color, orientation, and the like. Differences in these fiber properties can translate into differences in zonal textile properties, such as basis weight, stretch properties, breathability, thermal resistance properties, pilling properties, abrasion resistance properties, color, drapability, hand feel or softness, water resistance, water repellency, hydrophobicity, hydrophilicity, and the like.

In at least some examples, the differences in properties as between the first unit volume and the second unit volume 1340 can be based, at least in part on, the difference(s) entanglement parameters. For example, fibers in the first unit volume 1338 can include an orientation in the z-direction that is based on (e.g., results from) being needled with forward-barb needles, whereas fibers in the second unit volume 1340 can include an orientation in the z-direction that is based on (e.g., results from) being needled with reverse-barb needles. In some examples, the fibers needled with reverse-barb needles extend more into the layer 1326 (e.g., based on the reverse barb pulling those fibers into that layer). In some examples, the fibers that are pulled into the layer 1326 can be needled to include a design that is created by the fibers 1320 having a different color than the fibers in the layer 1326.

In examples, the first fibers 1304, the fourth fibers 1326, or a combination thereof can operate as a common substrate for linking the zones 1334 and 1336. That is, the zones 1334 and 1336 with different properties can effectively be within the same layer (e.g., 1344) of the composite 1330 and connected as part of a continuous entangled web by way of the first fibers 1304 (or the first layer 1342) and/or the fourth fibers 1326 (or the third layer 1346).

In some examples, one or more of the layers 1342, 1344, and 1346 can include a textile other than nonwoven textile or a fiber web. For example, one or more of the layers 1342, 1344, and 1346 can include a knit textile, a woven textile, or a film. In at least one example, the layer 1342 can include a woven textile or a knit textile, and the second fibers 1314 and the third fibers 1320 can be deposited on the woven textile or the knit textile (e.g., deposited by the gantry system). The woven textile or the knit textile can operate or function as a common substrate for linking the zones 1334 and 1336 (and the fibers making up those zones).

In at least some examples, the various portions of the composite textile 1330 that are coupled to one another can be integrally formed based on a continuous fiber web extending through, and joining, two separate pattern pieces. For example, in some instances, the zones 1334 and 1336 having different properties are integrally formed based on a continuous fiber web extending through, and joining, the zones 1334 and 1336 to one another. In some examples, the integrally formed composite textile can omit seams joining the various zones. Among other things, the omission of seams can reduce the likelihood of the properties of the composite textile 1330 being impacted by seam structures (e.g., stitches, adhesives, thermal bonds, etc.), which can sometimes affect stretch properties, drape, etc.

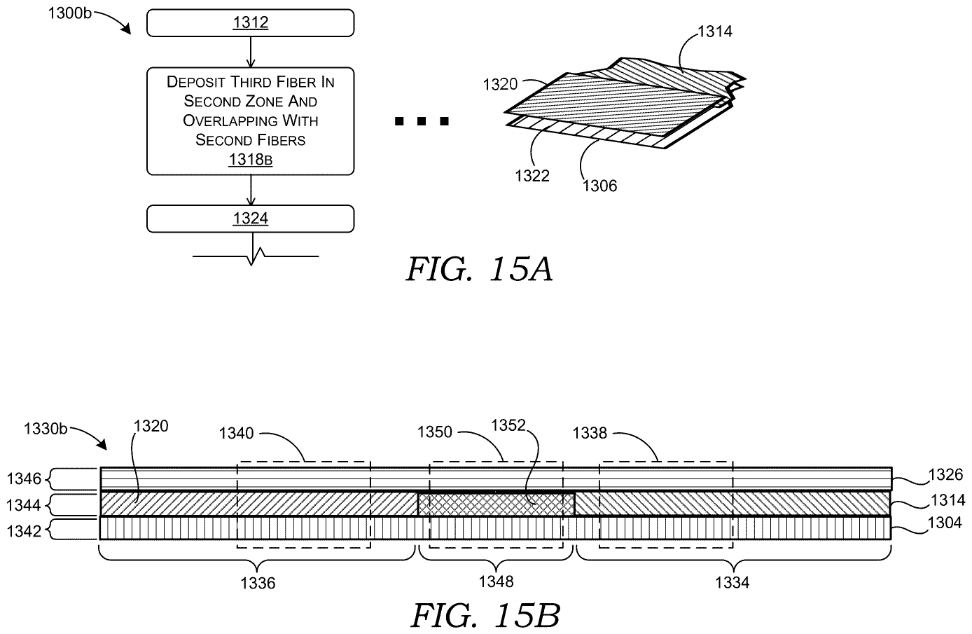

FIG. 13 depicts the method 1300 based on an example, including depositing the second fibers 1314 and the third fibers 1320. In FIG. 13, the second fibers 1314 and the third fibers 1320 can be deposited adjacent to one another within a common layer. Referring now to FIGS. 15A and 15B, another example is depicted and the third fibers 1320 can be deposited such that they at least partially overlap with the second fibers 1314. That is, in at least one example, a process 1300b (FIG. 15A) that is similar to the method 1300 can be carried out, including the operation at step 1312, which includes depositing the second fibers 1314 in the first zone (e.g., a first zone of the layer 1342 that can include a nonwoven layer with fiber, a woven layer, or a knit layer). In addition, operation 1318b can include depositing the third fibers 1320 such that they at least partially overlap the second fibers 1314. Following operation 1318b, the process can proceed similar to the method 1300, such as by depositing, at step 1324, the fourth fibers 1326. Unless otherwise described the composite textile 1330b can include any of the properties associated with or described with respect to the textile 1330.

In at least some examples, the composite textile 1330 can include a transition from the first zone 1334 to the second zone 1336, and the transition can be positioned in the same layer of the composite textile (e.g., intra-layer or within the same stratum). For example, referring to FIG. 15B, another view of a cross-section is depicted (similar to FIG. 14B), and in FIG. 15B, the composite textile 1330b includes a transition zone 1348 positioned between (intra plane or within the same layer or same stratum) the second fibers 1314 and the third fibers 1320. As described with respect to FIG. 15A, the transition zone 1348 can be formed by overlapping (e.g., by the gantry system) the third fibers 1320 with the second fibers 1314 when the third fibers 1320 are deposited (e.g., a portion of the third fibers 1320 are deposited over top a portion of the second fibers 1314). Based at least in part on the various fibers being coupled (e.g., at 1328 such as via needle entanglement), the first fibers 1304 (or the textile of the first layer 1342 that can include woven or knit), the fourth fibers 1326, or a combination thereof can operate as a common substrate for linking the zones 1334, 1336, and 1348.

In at least some examples, the various portions of the composite textile 1330b that are coupled to one another can be integrally formed based on a continuous web of fibers extending between the portions. In some instances, the composite textile 1330b can omit seams joining two separate pattern pieces. For example, in some instances, the zones 1334, 1336, and 1348 are integrally formed based on a continuous fiber web extending through and among the zones 1334, 1336, and 1348 to one another.

The transition zone 1348 can be associated with a unit volume 1350. In at least some examples, the transition zone 1348 and/or the unit volume 1350 can include fifth fibers 1352, which includes a blend of the second fibers 1314 and the third fibers 1320. In addition, fifth fibers 1352 can contribute to the transition zone 1348 and/or the unit volume 1350 having textile properties that have values (e.g., when quantified) in between the textile properties of the first zone 1334 and the second zone 1336, such as modulus of elasticity, basis weight, stretch properties, breathability, thermal resistance properties, pilling properties, abrasion resistance properties, color, drapability, hand feel or softness, water resistance, water repellency, hydrophobicity, hydrophilicity, and the like.

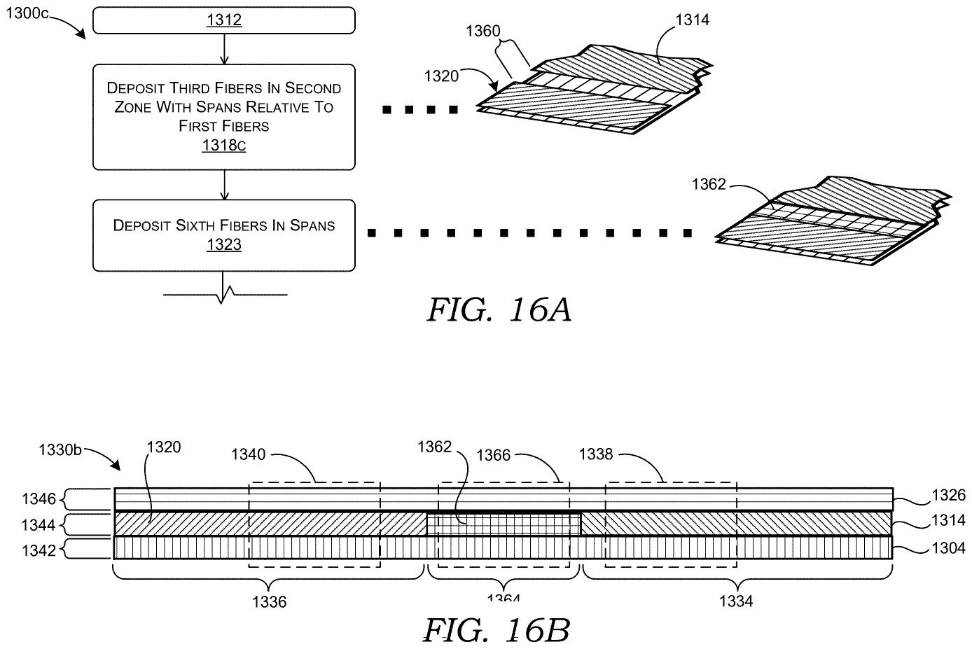

Referring to FIGS. 16A and 16B, another variation or addition to the method 1300 is depicted, and in FIG. 16A the method is identified as 1300c, which can be used to construct the composite textile 1330c. In some examples, the third fibers 1320 can be deposited such that they do not overlap the second fibers 1314. Stated differently, the deposit of the second fibers 1314 can be spaced apart from the deposit of the third fibers 1320 (by some intervening spans 1360). Unless otherwise described the composite textile 1330c can include any of the properties associated with or described with respect to the textile 1330.

In at least one example, the process 1300c that is similar to the method 1300 can be carried out, including the operation at step 1312, which includes depositing the second fibers 1314 in the first zone. In addition, operation 1318c can include depositing the third fibers 1320 such that a spans 1360 is between at least a portion of the second fibers 1314 and the third fibers 1320. In at least one example, the process 1300c can include depositing, at operation 1323, sixth fibers 1362 (e.g., compositionally similar to first fibers, compositionally similar to fourth fibers, or some other set of fibers that are different from the second fibers 1314 and the third fibers 1320), such that they are positioned in the spans 1360. In examples, an ability of the gantry system to move in the x-y orientation contributes to the deposit of the sixth fibers 1362 in the spans 1360 or in a position associated with the spans 1360.

For example, the sixth fibers 1362 can be deposited prior to depositing the second fibers 1314 and the third fibers 1320. (Although in the flow chart of FIG. 16A, step 1312 is depicted as before 1323, in some examples, the operation of 1323 can be executed before 1312, or in some other order.) The sixth fibers 1362 can be deposited after depositing the second fibers 1314 and before depositing the third fibers 1320. The sixth fibers 1362 can be deposited after depositing the second fibers 1314 and the third fibers 1320. Following operation 1323, the process can proceed similar to the method 1300, such as by depositing, at step 1324, the fourth fibers 1326.

In at least some examples, the composite textile 1330c can include a transition from the first zone 1334 to the second zone 1336, and the transition can be positioned in the same layer of the composite textile. For example, referring to FIG. 16B, another view of a cross-section is depicted (similar to FIGS. 14B and 15B), and in FIG. 16B, the composite textile 1330c includes a transition zone 1364 positioned between (intra plane or within the same layer or same stratum) the second fibers 1314 and the third fibers 1320. In at least some examples, the transition zone 1364 can be associated with a unit volume 1366. As described with respect to FIG. 16A, the transition zone 1364 can include the sixth fibers 1362 in the spans 1360 between the third fibers 1320 and the second fibers 1314.

Based at least in part on the various fibers being coupled (e.g., at 1328 such as via entanglement), the first fibers 1304 (or the textile of the first layer 1342 that can include woven or knit), the fourth fibers 1326, or a combination thereof can operate as a common substrate for linking the zones 1334, 1336, and 1364. In at least some examples, the various portions of the composite textile 1330c that are coupled to one another can be integrally formed based on a continuous web of fibers extending between the portions. In some instances, the composite textile 1330c can omit seams joining two separate pattern pieces. For example, in some instances, the zones 1334, 1336, and 1364 are integrally formed based on a continuous fiber web extending through and among the zones 1334, 1336, and 1364 to one another.

In at least some examples, the transition zone 1364 and/or the unit volume 1366 can include the sixth fibers 1362, which can include fibers having the same properties as the first fibers 1304, as the fourth fibers 1326, or as some other fibers that are different from the second fibers 1314 and the third fibers 1320 (and also different from the first fibers 1304 and the fourth fibers 1326). In addition, sixth fibers 1362 can contribute to the transition zone 1364 and/or the unit volume 131366 having textile properties that have values (e.g., when quantified) different from the first zone 1334 and the second zone 1336, such as modulus of elasticity, basis weight, stretch properties, breathability, thermal resistance properties, pilling properties, abrasion resistance properties, color, drapability, hand feel or softness, water resistance, water repellency, hydrophobicity, hydrophilicity, and the like.

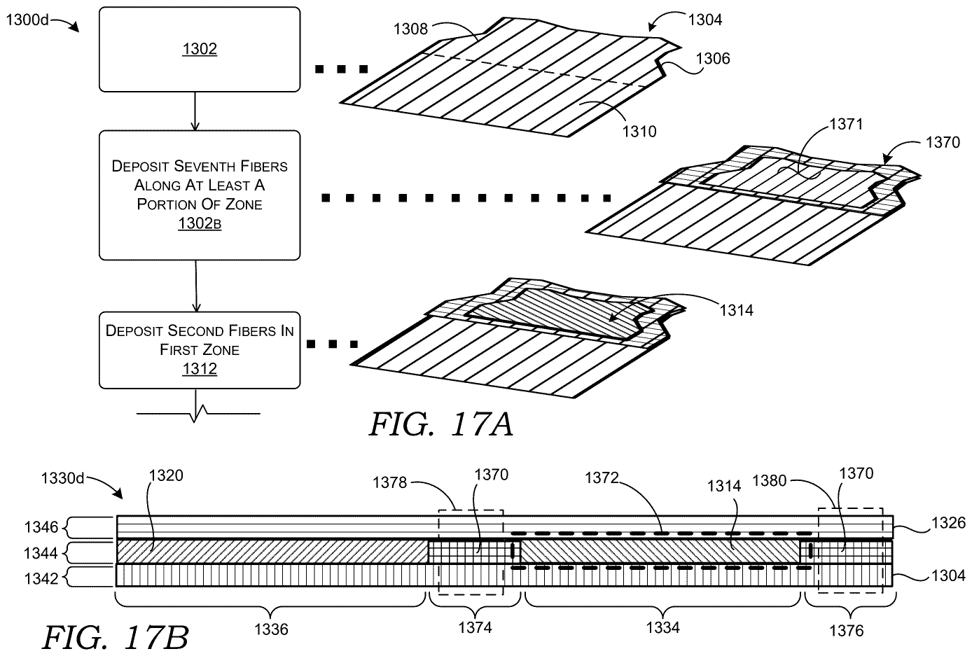

Referring to FIGS. 17A and 17B, an example is depicted, and in FIG. 17A the method is identified as 1300d. The method 1300d can include at least some of the same or similar operations as described with respect to FIG. 13, and can be used to make a composite textile 1330d that includes any of the same properties as the composite textile 1330, unless otherwise described.

In at least one example, steps of the process 1300d similar to the method 1300 can include the operation at step 1302, which includes depositing the first fibers 1304 (or some other textile layer, such as a woven textile or a knit textile). As explained with respect to the method 1300, the first fibers 1304 and/or the shape in which the first fibers 1304 are arranged can include one or more zones (e.g., 1308 and 1310). In addition, operation 1302b can include depositing seventh fibers 1370 onto the first fibers 1304. For example, the seventh fibers 1370 can be deposited in a pattern that follows an outline of at least a portion of a boundary 1306 associated with the first zone 1308. In examples, an ability of the gantry system to move in the x-y orientation contributes to the deposit of the seventh fibers 1370 in the pattern.

Further, the process 1300d can include, at operation 1312, depositing the second fibers 1314 in the first zone 1308, and in particular within a portion that is bounded along a perimeter edge by the seventh fibers 1370. In at least some examples, the first fibers 1304 and the seventh fibers 1370 can form a depressed region 1371 (e.g., compartment, pocket, etc.) to receive the second fibers 1314 (e.g., where the first fibers 1304 in the first zone 1308 are the bottom of the depressed region and the seventh fibers 1370 are the sides of the depressed region). In some examples, seventh fibers 1370 can form an intra-layer perimeter around one or more sides of the second fibers 1314 and/or the third fibers 1320.

In some examples, the process 1300d can include one or more additional steps, such as depositing the third fibers 1320 in the second zone 1310. As such, the third fibers 1320 can be in the same layer of the composite textile as the second fibers 1314 and the seventh fibers 1370. In addition, the process 1300d can include depositing the fourth fibers 1326 over the second fibers 1314, the seventh fibers 1370, and/or the third fibers 1320. In some examples, the composite can include the second fibers 1314 in the depressed region with the third fibers 1320 and/or the fourth fibers 1326 omitted.

In at least some examples, referring to FIG. 17B, the composite textile 1330d can include a one or more different fibers and/or layers forming an enclosure or pocket 1372 around the second fibers 1314. For example, on a first side the second fibers 1314 can be enclosed by the first fibers 1304 or by some other textile layer forming the layer 1342 (e.g., a knit textile or a woven textile). In addition, on a second side that opposes the first side the second fibers 1314 can be enclosed by the fourth fibers 1326 or by some other textile layer forming the layer 1346. Further, along the perimeter and within the same layer, the second fibers 1314 can be enclosed by the fibers 1370. In examples, the enclosure 1372 can operate to isolate the fibers 1314 (and the functionality imparted by the fibers 1314), to contain the fibers 1314, and to protect the fibers 1314.

In at least some examples, the composite textile 1330d can include one or more enclosure zones (e.g., on one or more sides of the second fibers 1314). For example, referring to FIG. 17B, the composite textile 1330d includes the enclosure zones 1374 and 1376 along different peripheral edges of the second fibers 1314. In at least some examples, the enclosure zones 1374 and 1376 can be associated with unit volumes 1378 and 1380. Based at least in part on the various fibers being coupled (e.g., at 1328 such as via entanglement), the first fibers 1304 (or the textile of the first layer 1342 that can include woven or knit), the fourth fibers 1326, or a combination thereof can operate as a common substrate for linking the zones 1334, 1374, and 1376. In at least some examples, the various portions of the composite textile 1330d that are coupled to one another can be integrally formed based on a continuous web of fibers extending between the portions. In some instances, the composite textile 1330d can omit seams joining two separate pattern pieces. For example, in some instances, the zones 1334, 1374, and 1376 are integrally formed based on a continuous fiber web extending through and among the zones 1334, 1374, and 1376 to one another.

In at least some examples, the enclosure zones 1374 and 1376 and/or the unit volumes 1378 and 1380 can include the seventh fibers 1370, which can include fibers having the same properties as the first fibers 1304, as the fourth fibers 1326, or as some other fibers that are different from the second fibers 1314 and the third fibers 1320 (and also different from the first fibers 1304 and the fourth fibers 1326). In addition, seventh fibers 1370 can contribute to the enclosure zones 1374 and 1376 and/or the unit volumes 1378 and 1380 having textile properties that have values (e.g., when quantified) different from the first zone 1334 and the second zone 1336, such as modulus of elasticity, basis weight, stretch properties, breathability, thermal resistance properties, pilling properties, abrasion resistance properties, color, drapability, hand feel or softness, water resistance, water repellency, hydrophobicity, hydrophilicity, and the like.

In at least some examples of the present disclosure, a composite textile can include a peripheral portion (e.g., perimeter edge or border) having fibers with a fiber orientation, which can be tailored, customized, and/or programmatically controlled, such as via the gantry system 10 with the fiber-delivery head and/or a needle-punch head moving in a path in the x-y orientation/plane.

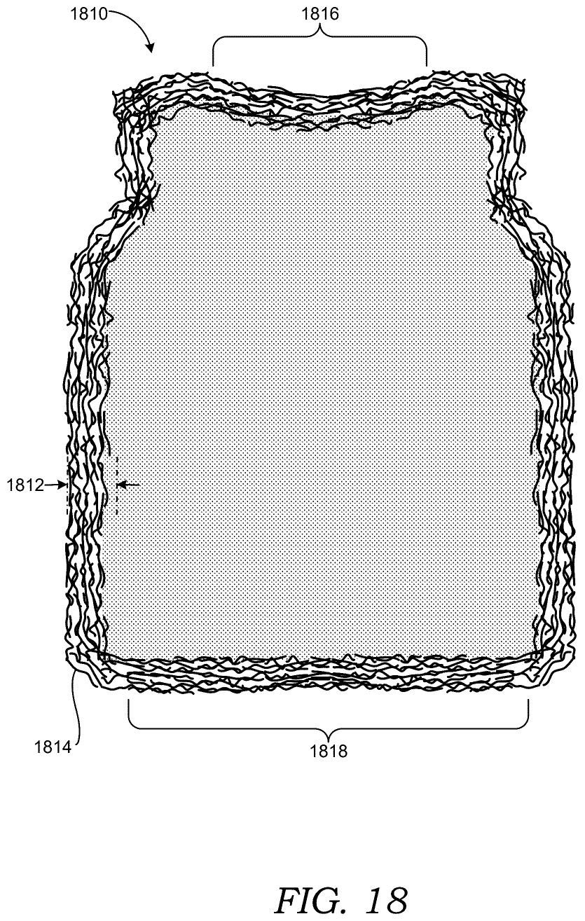

For example, referring to FIG. 18, a composite textile 1810 is depicted, which can include a pattern piece (e.g., similar to the pattern piece 1208), and the composite textile 1810 includes a peripheral border 1812 and fibers 1814 having a fiber orientation generally aligned with the peripheral border 1812. In some examples, the peripheral border 1812 can include a margin of a shape that is created as part of a larger textile (e.g., the larger textile extending beyond the peripheral border is not depicted in FIG. 18).

The composite textile 1810 can include any of the composite textiles described in the specification, with any of the fibers or textiles described herein, and with one or more layers forming the composite textile. In at least some examples, the peripheral border 1812 is associated with a 2D shape or 3D shape that is configured based on one or more various parts of an apparel article. For example, in instances in which the peripheral border outlines a pattern piece, the 2D or 3D shape can be based on the structure the pattern piece will form when incorporated into a garment (e.g., based on the structure the pattern piece might form when incorporated into a wearable apparel as a front, back, sleeve, hood, pocket, etc.). In examples, a shape associated with the pattern piece can be associated with seams that attach the pattern piece to another pattern piece when fashioning the wearable article or to trim pieces finishing an edge of the pattern piece. For example, a perimeter shape of the pattern piece can be identified by tracing/following the seams continuously around the periphery of the pattern piece. In some examples, a perimeter shape of the pattern piece can be determined extracting the pattern piece from a wearable article by cutting along the seams. In some examples, properties associated with the peripheral border 1812 and/or the 2D shape (e.g., dimensions, length, orientation, angle, radius, etc.) associated with the pattern piece can be determined by laying the pattern piece flat and determining an outline of the pattern piece. In some examples, the pattern piece can be cut and the perimeter edge can be determined based on the cut line or the tool path of the cutting device. Any other known methods for determining a shape of a pattern piece or the perimeter edge of a pattern piece can be implemented.

In at least some examples, the peripheral border can outline a logo or other shape formed on a larger textile.

In at least some examples, the peripheral border 1812 can circumscribe multiple sides (e.g., all sides) of the 2D shape associated with the composite textile 1810. For example, the peripheral border 1812 can include one or more segments that are curvilinear (e.g., 1816) or rectilinear (e.g., 1818) and that, in combination, form or circumscribe multiple sides (e.g., all sides) of the composite textile 1810.

The peripheral border 1812 can in some instances include a margin along the perimeter of the composite textile 1810. For example, the peripheral border can include a margin that is about 1 cm wide. In some examples, the margin can be less than about 1 cm or more than about 1 cm. In some examples the margin can be about 2 cm, or about 3 cm, or about 4 cm, or about 5 cm. In some examples, the margin can be larger than 5 cm. In some examples, the margin can be about the diameter or width of a delivery chute associated with a fiber-delivery head.

In at least some examples of the present disclosure, a fiber orientation of the fibers 1814 is based on (e.g., characterized in relation to) the peripheral border 1812 and/or the 2D shape associated with the pattern piece. For example, in at least one example of the present disclosure, average fiber orientation of fibers along a given segment is aligned with (e.g., substantially parallel with) the given segment. In addition, the peripheral border 1812 can have two or more segments that are angled or curved with respect to one another, and the average fiber orientation associated with each segment is aligned with the given segment. In at least some examples, the peripheral border 1812 can have a perimeter length (around the entire composite textile 1810) and a minimum percentage of the perimeter length can include segments with a fiber orientation that is aligned therewith. In some examples, the minimum percentage is at least about 50%, at least about 60%, or at least about 70%, or at least about 80%, or at least about 90%, or about 100%.

In at least some examples of the present disclosure, fiber orientation of fibers is characterized relative to other fibers in the peripheral border. For example, the fiber orientation can continuously and smoothly transition from one position to a subsequent position, such as in a dead-reckoning type manner. Stated differently, a first fiber orientation of a first fiber can be followed for a given distance, and within that distance, a second fiber orientation of a second fiber is identified that intersects the first fiber orientation. In at least some examples, the process iteratively continues and the consecutive fiber orientations traverse a path that extends around the pattern piece (e.g., continuously circumscribes the pattern piece). In some examples, the given distance is less than about 1 cm, or less than about 2 cm, or less than about 3 cm.

In at least some examples, the path traversed by the identified fiber orientations corresponds with the 2D shape associated with the pattern piece. For example, in some instances, the path includes an angle that is congruent with an angle of the pattern piece. In some instances, the path is similar in that the angles or radii of the path are within a threshold value of the corresponding angles or radii of the shape of the pattern piece. In some instances, the threshold value is about 10 degrees, or about 5 degrees.

In at least some examples, depositing the fibers via the gantry system 10 with the fiber-delivery head moving in a path in the x-y orientation/plane allows for the average fiber orientation to be aligned with a given segment. In some examples, the gantry system 10 can include other components to increase the likelihood that a fiber will retain an orientation that is aligned with the tool path. For example, the substrate on which the fiber is deposited can contribute to holding the fiber in position. In some examples, the tool head can include a roller that follows the fiber-delivery head and helps to compress the fibers in position. In at least some examples, the needle-entanglement head moves in the x-y plane as it needles in the z-direction, and this movement in the x-y plane can also contribute to orienting the fibers in a direction of the tool path (e.g., where the needles also drag the fibers as they are pushing and/or pulling in the z-direction.

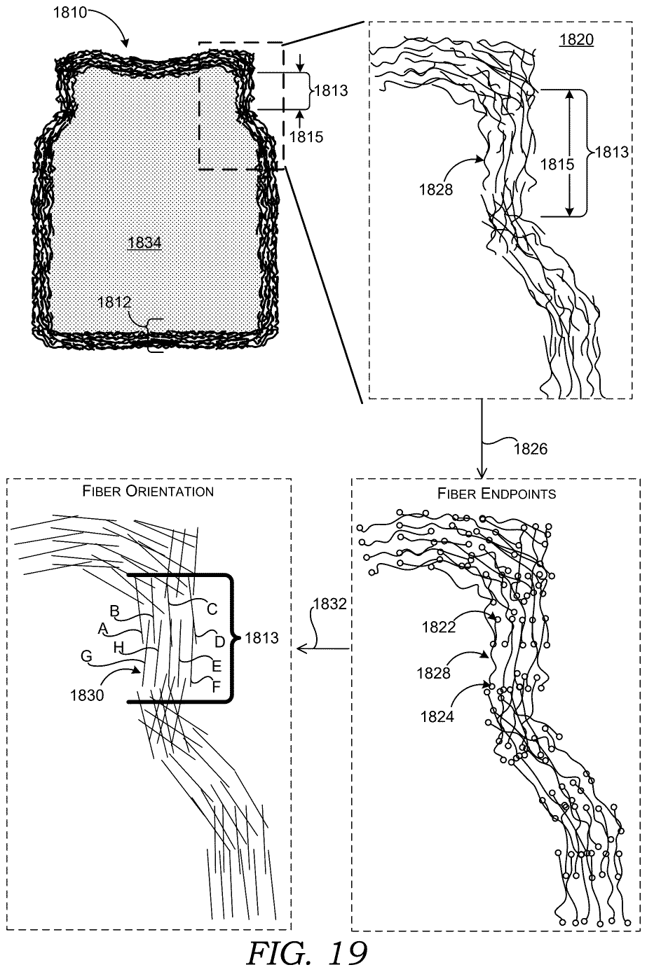

Fiber orientation can be determined in various manners. Referring to FIG. 19, the composite textile 1810 is depicted together with an enlarged portion 1820 of the peripheral border 1812. In at least one example, fiber endpoints (e.g., 1822 and 1824) can be determined 1826 for a given fiber 1828. For example, endpoints can be determined on a physical sample of the composite textile (e.g., by visually inspecting the physical example). In some instances, endpoints can be determined based on an enlarged image of the composite textile.

In at least some examples, for a given fiber (e.g., 1828) a connecting line (e.g., 1830) can be generated 1832 based on the two endpoints of a given fiber (e.g., where the connecting line 1830 is based on the endpoints 1822 and 1824). The connecting line can be used to estimate or represent the fiber orientation for a respective fiber.

In at least some examples, when assessing fiber orientation, such as from a plan view perspective as depicted in FIG. 19, the fiber orientations are flattened into a 2D plane (e.g., based on the x-y orientations).

In at least one example, when determining a fiber orientation associated with a segment or portion of the peripheral border 1812, the segment is identified based on a specified segment length along the peripheral border. An example of a segment 1813 is depicted, which is associated with a length 1815. In some examples, a segment length 1815 can be between about 3 cm and about 7 cm or about 5 cm. In addition, a minimum number of fiber orientations are determined for fibers having at least a portion within the identified segment. In some examples, the minimum number of fibers is five fibers, and in other instances, more fibers can be evaluated, such as at least 10 fibers, at least 20 fibers, or at least 30 fibers. In FIG. 19, eight fibers (A-H) are identified and could be used to determine a fiber orientation associated with the segment (e.g., based on an average, median, etc.).

In at least some examples, the peripheral border 1812 and fibers 1814 having a fiber orientation generally aligned with the peripheral border 1812 can provide various functionality and impart various properties to the composite textile 1810. In at least some examples, the fibers 1814 having the fiber orientation aligned with the peripheral border can provide foundation or base layer substrate on which subsequent fibers are deposited when making a pattern piece “to shape” in a gantry system (e.g., as opposed to a generic blank that is later cut to shape).

In at least some examples, the fibers 1814 having the fiber orientation aligned with the peripheral border can provide the sides of a pocket or enclosure or depressed region for receiving the deposit of other fibers (e.g., in the region 1834).

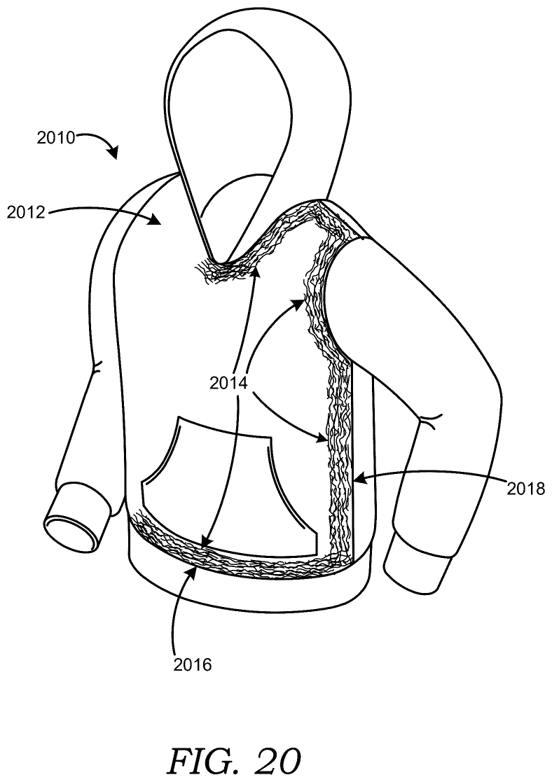

In at least some examples, the fibers 1814 having the fiber orientation aligned with the peripheral border can provide structural integrity to a pattern piece edge that can improve seaming operations and/or improve the strength of a seam in an assembled garment. In some examples, fibers that are oriented in the same direction as the longitudinal orientation of the seam can help to tailor the amount of stretch associated with the seam. For example, referring to FIG. 20, an example of a wearable apparel 2010 is depicted having a pattern piece 2012 in which the orientation of the fibers 2014 along the peripheral border is generally aligned with the seams 2016 and 2018, which attach the pattern piece 2012 to other pattern pieces and/or to trim pieces. In contrast to more conventional approaches in which fiber orientation is limited by carding, cross-lapping, etc., in the present disclosure, the fibers 2014 are aligned with multiple seams having different orientations.

In at least some examples, the fibers 1814 can contribute to forming a boundary around a shape that is constructed onto a face of the composite textile. For example, the composite textile 1810 can include a bottom fiber web having first fibers of a first color and a top fiber web having second fibers of a second color (different from the first color). The fibers 1814 can include first fibers of the bottom fiber web that are pulled to the surface (e.g., via reverse barb) of the top fiber web and that, based on the different color, can create a boundary between the first fibers having one color and the second fibers having a different color. In some examples, fibers inside the boundary can also be needled with a reverse barb to “fill in” the shape with the first fibers. In some examples, the portion of the composite textile inside the boundary can be formed with the second fibers, such that the fibers 1814 outline the shape with the second fibers on the inside of the shape.

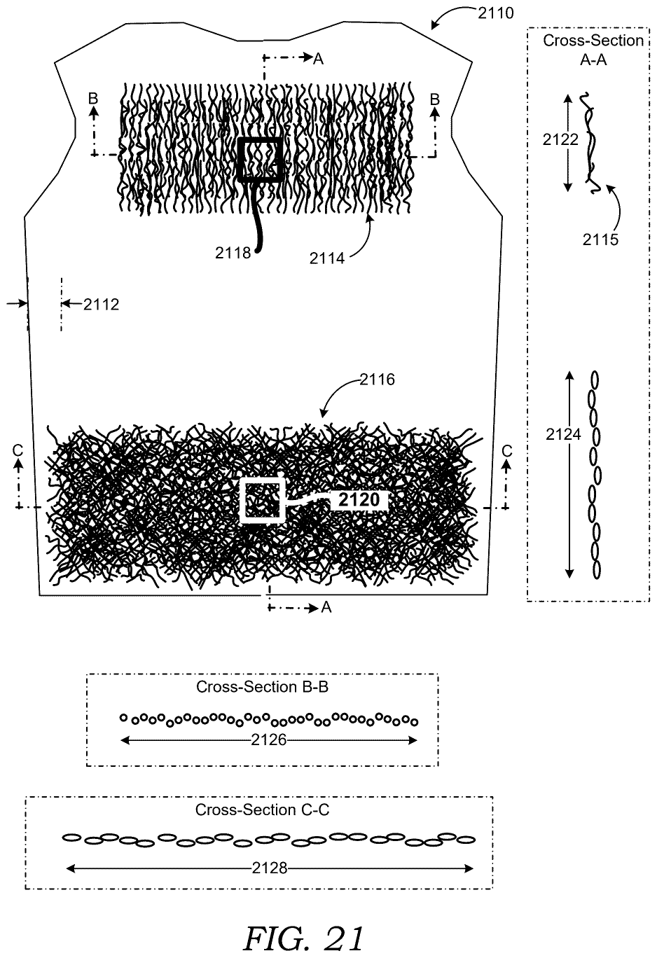

FIGS. 18-20 (and the related description) are associated with fiber orientation as it can relate to a peripheral border. In some examples, one or more zones within a pattern piece can include zonal fiber orientation configured to impart certain properties. For example, referring to FIG. 21, a composite textile 2110 is depicted, which can include a pattern piece (e.g., similar to the pattern piece 1208), and the composite textile 2110 includes a peripheral border 2112 and a first zone 2114 and a second zone 2116, which are within the peripheral border (e.g., the peripheral border continuously circumscribes the zones 2112 and 2114). In addition, FIG. 21 includes a first cross section A-A, a second cross section B-B, and a third cross section C-C.

The composite textile 2110 can include any of the composite textiles described in the specification, with any of the fibers or textiles described herein, and with one or more layers forming the composite textile. In at least some examples, the first zone 2114 and the second zone 2116 are integrally formed. In some examples, a seam might not separate the first zone 2114 and the second zone 2114, such that the zones are portions of the same pattern piece (e.g., without being joined only via a seam).

In examples, the first zone 2114 includes fibers having a first fiber orientation, and the second zone includes fibers having a second fiber orientation, which is different from the first fiber orientation. For example, the first zone 2114 can include a unit area or a unit volume 2118 having a first fiber orientation property across a fibers in the area or volume 2118. In addition, the second zone 2116 can include a unit area or a unit volume 2120 having a second fiber orientation property across a fibers in the area or volume 2120, and first fiber orientation property is different from the second fiber orientation property.

In some examples, the fiber orientation property can include a fiber orientation variance, including a quantification of how different the fiber orientations are in a given unit area or volume. In at least one example, the first unit area or volume 2118 can include a lower fiber orientation variance than the second unit area or volume 2120. Stated differently, the orientations of the fibers in the first unit area or volume 2118 can be more consistent than the fibers in the second unit area or volume 2120. In at least one example, variance can be calculated by determining a mean orientation (e.g., man direction vector) and measuring the spread of individual orientations relative to the mean.

In some examples, the fiber orientation property can include a comparison of the average fiber orientation as between the unit areas or volumes 2118 and 2120. For example, a first average fiber orientation associated with the first unit 2118 can be angled with respect to a second average fiber orientation associated with the second unit 2120.

In at least some examples, the fiber orientations can impart desired properties in a subject zone. For example, in the first zone 2114, the fiber orientation (e.g., less variance) can contribute to the first zone 2114 be more resistant to stretch or elongate (e.g., have a higher modulus of elasticity) in the direction 2122, as compared to in the direction 2124 and as compared to the second zone 2116 in the directions 2126 and 2128. For example, the longitudinal orientation of the fibers 2115, as depicted in the cross section B-B, can resist stretch or elongation in the direction 2122 or provide lockdown in the direction 2122 of the first zone 2114. In addition, in the first zone 2114, the fiber orientation can contribute to the first zone 2114 be less resistant to stretch or elongation (e.g., have a higher modulus of elasticity) in the direction 2123. In some examples, the lower modulus can contribute to fit in given zone by allowing the textile to conform to a wearer's body.

In at least some examples, the fiber orientation in the second zone 2116 (e.g., more variance) can contribute to the second zone 2116 be more dimensionally stable across multiple orientations or axes of stretch (e.g., having more consistent modulus of elasticity in different directions 2124 and 2126), as compared to the more variable stretch properties associated with the first zone 2114. Higher dimensional stability can contribute to various properties, such by limiting textile growth in a given direction and providing a stable textile to affix other pattern pieces (e.g., the pattern piece in FIG. 12 for the front pocket).

In at least some examples, a pattern piece or any other textile portion can include at least some fibers having a relatively consistent fiber orientation. For example, the at least some fibers can have a consistent orientation, similar to the zone 2114, and the at least some fibers can extend through any portion of the pattern piece or other textile portion. The at least some fibers with the consistent orientation can extend through at least 30% of the textile portion, 40% of the textile portion, 50% of the textile portion, 60% of the textile portion, 70% of the textile portion, 80% of the textile portion, 90% of the textile portion, and up to 100% of the textile portion. In examples, the consistent orientation can be achieved by a fiber-delivery head coupled to a gantry, where the fiber-delivery head traverses across a given portion of pattern or panel or other form of textile, such that fibers laid down in a first pass can include a similar orientation as the fibers laid down in one or more subsequent passes that are incrementally adjacent.

In at least some examples, fibers in the first zone 2112 and fibers in the second zone 2116 can differ in one or more other respects (e.g., without necessarily differing in the x-y orientation). For example, fibers in one of the zones can have a fiber z-orientation that results from being needle entangled with a reverse barb, as compared to the other zone that may have fibers with a fiber orientation that results from being needle entangled with a forward barb. Fibers being needled with a reverse barb can, in some instances, have loops, fiber ends, or other fiber portions that are positioned more on one of the faces, as compared to the fibers that are needled with the forward barbs (or are otherwise not needled with the reverse barbs). As such, where the fibers that are needled with the reverse bars have a different color, those fibers can be used to create a design on the face.

In at least some examples, entangling fibers via the gantry system 10 with the needle-punch head moving in a path in the x-y orientation/plane aligns at least a portion of the fibers in an orientation that is aligned with the path of the needle-punch head. Stated differently, as the needles from the needle-punch head reciprocate (e.g., moving up and down in a given stroke), the needle head is moved in the x-y plane along a path that corresponds with a pattern, shape, or design, and the needles drag the at least a portion of the fibers along the path as they temporarily engage during the entanglement stroke (e.g., as the fiber(s) is formed into a stitch). As a result, at least a portion of a fiber (e.g., a segment of the fiber) is manipulated into an orientation or direction aligned with the direction the needle-punch head was moving while the entanglement stroke was performed.

Some examples of the present disclosure include any textile constructed using a fiber-delivery head on a gantry system, as described in this disclosure. Textiles constructed using such a gantry system can have various properties. In some examples, the various properties can include zonal properties, more consistent fiber orientation (e.g., along a peripheral border and/or in any other region), and any and all combinations thereof.

### Example Clauses

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting. The following clauses may be rewritten as claims.

Clause 1. A system for creating a nonwoven textile from fibers, the system comprising: a gantry comprising one or more tool holders; a fiber-delivery head coupled to the one or more tool holders; and a substrate positioned below the fiber-delivery head, the substrate having a surface defining a first x-y plane; wherein the gantry is configured to move the fiber-delivery head in at least a second x-y plane; and wherein the fiber-delivery head is configured to deposit fibers directionally based on movement of the fiber-delivery head in the second x-y plane.

Clause 2. The system of clause 1, wherein the gantry is further configured to move the fiber-delivery head in a z direction orthogonal to the second x-y plane.

Clause 3. The system of clause 1 or clause 2, wherein the fiber delivery head comprises a fiber-separator system that selectively receives a first fiber collection of a first material and separates fibers from the first fiber collection of the first material.

Clause 4. The system of clause 3, wherein the fiber-separator system selectively receives a second fiber collection of a second material and separates fibers from the second fiber collection of the second material.

Clause 5. The system of clause 4, wherein the first material and the second material have different properties.

Clause 6. The system of any of clauses 1 through 5, wherein the fiber delivery head comprises a fiber-separator system that selectively feeds at least one fiber collection of a plurality of fiber collections and separates fibers from the selected at least one of the plurality of fiber collections.

Clause 7. The system of clause 6, wherein each of the plurality of fiber collections is a different material.

Clause 8. The system of clause 6, wherein the fiber-separator system selectively and simultaneously feeds at least two fiber collections of the plurality of fiber collections and separates fibers from the selected at least two fiber collections.

Clause 9. The system of clause 5, wherein the fiber-separator system comprises a plurality of sets of spaced rollers, each set of rollers corresponding to one of the plurality of fiber collections and receiving one of the plurality of fiber collections, each set of rollers being operable to separate fibers from the corresponding one of the plurality of fiber collections.

Clause 10. The system of clause 9, wherein each set of the plurality of sets of spaced rollers comprises a feed roller, the system further comprising a plurality of motors, each motor operably coupled to a corresponding one of the feed rollers, each motor selectively operable to rotate the corresponding feed roller to separate fibers from the sliver received by the set of spaced rollers.

Clause 11. The system of clause 10, wherein the fiber-delivery head further comprises a chute below the fiber-separator system, the chute directing separated fibers onto the substrate.

Clause 12. The system of clause 11, wherein the fiber-delivery head further comprises a propulsion system coupled to the chute, the propulsion system operable to move the separated fibers down the chute.

Clause 13. The system of clause 12, wherein the propulsion system is a compressed air tube directed down the chute.

Clause 14. The system of clause 11, wherein the fiber-delivery head further comprises a bottom plate below the chute, the bottom plate having at least one nozzle to direct the separated fibers onto the substrate.

Clause 15. The system of clause 14, wherein the bottom plate comprises multiple nozzles, each having one of a different size or shape, and wherein a selected one of the multiple nozzles is moveable into a position below the chute.

Clause 16. The system of clause 11, further comprising a first nozzle coupled to the fiber delivery head, the first nozzle having an orifice to direct the separated fibers onto the substrate.

Clause 17. The system of clause 16, further comprising a second nozzle interchangeable with the first nozzle, the second nozzle having an orifice of a different size or shape than the orifice on the first nozzle.

Clause 18. The system of clause 11, further comprising a first fiber entanglement head that is attachable to the one or more tool holders.

Clause 19. The system of clause 18, further comprising a second fiber-entanglement head interchangeable with the first fiber-entanglement head, the second fiber-entanglement head configured to provide one or more different entanglement parameters.

Clause 20. The system of clause 19, further comprising a laser that is attachable to the one or more tool holders.

Clause 21. The system of clause 11, further comprising a roller.

Clause 22. The system of clause 10, wherein the speed of each motor is variable to adjust the feed rate of the corresponding sliver through the corresponding set of rollers.

Clause 23. The system of any of clauses 1 through 22, wherein the substrate is a bed of spaced flexible bristles.

Clause 24. A method of manufacturing a nonwoven textile, comprising: delivering selected fibers onto a substrate in a pattern, the pattern created by moving a fiber-delivery head in an x-y plane above the substrate; and entangling the selected fibers to create a nonwoven textile in the shape of the pattern.

Clause 25. The method of manufacturing a nonwoven textile of clause 24, wherein the delivering step comprises selectively feeding at least one of a plurality of slivers into the fiber-delivery head.

Clause 26. The method of manufacturing a nonwoven textile of clause 25, wherein the delivering step comprises selectively feeding two or more of a plurality of slivers into the fiber-delivery head.

Clause 27. The method of manufacturing a nonwoven textile of clause 26, further comprising determining a desired orientation for the selected fibers, and moving the fiber-delivery head in the x-y plane above the substrate based on the determined desired fiber orientation.

Clause 28. The method of manufacturing a nonwoven textile of clause 27, further comprising determining a desired fiber density at a location on the pattern, and adjusting a rate of movement of the fiber-delivery head in the x-y plane above the substrate based on the determined desired fiber density.

Clause 29. The method of manufacturing a nonwoven textile of clause 28, further comprising determining a desired fiber density at a location on the pattern, and adjusting a rate of feeding the selected sliver of the plurality of slivers into the fiber-delivery head.

Clause 30. The method of manufacturing a nonwoven textile of clause 29, further comprising delivering different fibers from different slivers in at least a first location and a second location on the pattern, to create different zonal properties at the first location compared to the second location.

Clause 31. The method of manufacturing a nonwoven textile of clause 30, further comprising delivering different combinations of fibers from different slivers in at least a first location and a second location on the pattern, to create different zonal properties at the first location compared to the second location.

Clause 32. The method of manufacturing a nonwoven textile of clause 31, wherein the delivering step further comprises selectively feeding the separated fibers through a nozzle.

Clause 33. The method of manufacturing a nonwoven textile of clause 32, further comprising selecting one of a plurality of spray patterns for the separated fibers, and delivering the fibers through a nozzle selected based on the selected spray pattern.

Clause 34. The method of manufacturing a nonwoven textile of clause 33, wherein the entangling comprises, in a first mechanical entanglement step, mechanically entangling a plurality of the fibers with a first number of needles across the pattern; and subsequent to the first mechanical entanglement step, at a second mechanical entanglement step, mechanically entangling a plurality of the fibers in an area that is a subset of the pattern with a second number of needles.

Clause 35. The method of manufacturing the composite nonwoven textile of clause 34, wherein the first number of needles is larger than the second number of needles.

Clause 36. A system for manufacturing a composite textile, the system comprising: an actuator and one or more tool holders, wherein the actuator is configured to move the one or more tool holders in two more axes; a fiber-delivery head that is attached to a tool holder of the one or more tool holders and is configured to deposit first fibers on a substrate; and one or more additional tools that are attachable to the one or more tool holders.

37.The system of clause 36, wherein the one or more additional tools comprise a fiber deposition head configured to deposit additional fibers on the first fibers.

Clause 38. The system of clause 37, wherein the fiber deposition head is configured to deposit spunbond fibers or meltbown fibers.

Clause 39. The system of any of clauses 36 through 38, wherein the one or more additional tools comprises an entanglement head.

Clause 40. The system of clause 39, wherein the entanglement head comprises a fluid entanglement head or a needle-punch head.

Clause 41. The system of any of clauses 36 through 40, wherein the one or more additional tools comprises an extrusion head.

Clause 42. The system of any of clauses 36 through 41, wherein the one or more additional tools comprises a print head.

Clause 43. The system of any of clauses 36 through 42, wherein the one or more additional tools comprises an embroidery head.

Clause 44. The system of any of clauses 36 through 43, wherein the one or more additional tools comprises a laser.

Clause 45. The system of any of clauses 36 through 44, wherein the one or more additional tools comprises a spray nozzle.

Clause 46. The system of any of clauses 36 through 45, wherein the actuator comprises a portion of a CNC gantry.

Clause 47. The system of any of clauses 36 through 46, wherein the two or more axes include an x-direction and a y-direction.

Clause 48. The system of clause 47, wherein the two or more axes include a z-direction.

Clause 49. The system of clause 48, wherein the two or more axes include a pitch articulation, a yaw articulation, and a roll articulation.

Clause 50. A substrate for use in creating a nonwoven textile from fibers, comprising: a base; and a plurality of spaced apart flexible bristles coupled to the base and extending upwardly from the base.

Clause 51. The substrate of clause 50, wherein the bristles each have a top spaced from the base, and wherein the bristles have a consistent height extending from the base to the top.

Clause 52. The substrate of clause 50 or clause 51, wherein the bristles are made from a fast recovery elastomeric material.

Clause 53. The substrate of any of clauses 50 through 52, wherein the bristles are cylindrical with a diameter of the bristles adjacent the base equal to a diameter of the top of the bristles.

Clause 54. The substrate of any of clauses 50 through 52, wherein the bristles have a diameter adjacent the base that is larger than a diameter at the top of the bristles.

Clause 55. The substrate of any of clauses 50 through 54, wherein the base is a continuous loop configured to be used as a conveyor belt, and wherein the top of the bristles faces outwardly from the loop.

Clause 56. The substrate of any of clauses 50 through 54, wherein the substrate is a stationary panel, with the top of the bristles facing upwardly.

Clause 57. The substrate of clause 50, wherein the bristles each have a top spaced from the base, and wherein the bristles have a variable height extending from the base to the top.

Clause 58. The substrate of clause 57, wherein the variable height of the bristles establishes a pattern.

Clause 59. The substrate of any of clauses 50 through 58, wherein the height of the bristles is between 15-25 millimeters.

Clause 60. A system for constructing a nonwoven textile, the system comprising: a needle-punch tool comprising one or more needles; one or more actuators that move the needle-punch tool in an x-y plane and that reciprocate the needle-punch tool, the one or more needles, or any combination thereof in a z-direction; a substate configured to support fibers in a position to be engaged by the one or more needles when the needle-punch tool, the one or more needles, or any combination thereof is reciprocated in the z-direction, wherein the substrate comprises a base and a plurality of spaced apart flexible bristles coupled to the base and extending upwardly from the base.

Clause 61. The system of clause 60, wherein the bristles each have a top spaced from the base, and wherein the bristles have a consistent height extending from the base to the top.

Clause 62. The system of clause 60 or clause 61, wherein the bristles compositionally comprise a fast recovery elastomeric material.

Clause 63. The system of any of clauses 60 through 62, wherein the bristles are cylindrical with a diameter of the bristles adjacent the base equal to a diameter of the top of the bristles.

Clause 64. The system of any of clauses 60 through 62, wherein the bristles have a diameter adjacent the base that is larger than a diameter at the top of the bristles.

Clause 65. The system of any of clauses 60 through 64, wherein the base is a continuous loop configured to be used as a conveyor belt, and wherein the top of the bristles faces outwardly from the loop.

Clause 66. The system of any of clauses 60 through 64, wherein the substrate is a stationary panel, with the top of the bristles facing upwardly.

Clause 67. The system of clause 62, wherein the bristles each have a top spaced from the base, and wherein the bristles have a variable height extending from the base to the top.

Clause 68. The system of clause 67, wherein the variable height of the bristles establishes a pattern.

Clause The system of any of clauses 60 through 68, wherein the height of the bristles is between 15-25 millimeters.

Clause 70. The system of any of clauses 60 through 69, wherein the one or more actuators are configured to concurrently move the needle-punch tool in the x-y plane and reciprocate the needle-punch tool, the one or more needles, or any combination thereof in the z-direction; and wherein the plurality of spaced apart flexible bristles are configured to bend when engaged by the one or more needles.

Clause 71. The system of clause 70, wherein the one or more actuators are configured to move the needle-punch tool in a curvilinear tool path.

Clause 72. The system of clause 71, wherein moving the needle-punch tool in the curvilinear tool path comprises moving the needle-punch tool in both an x-direction and a y-direction in the x-y plane.

Clause 73. The system of any of clauses 60 through 72, wherein the one or more needles are reverse-barb needles.

Clause 74. A method of constructing a nonwoven textile, the method comprising: depositing fibers above a substrate, wherein the substrate comprises a base and spaced apart flexible bristles coupled to the base and extending upwardly from the base; at least partially entangling the fibers by concurrently moving a needle-punch tool in an x-y plane and reciprocating in a z-direction the needle-punch tool, one or more needles operatively associated with the needle-punch tool, or any combination thereof; and contacting, with the one or more needles, the spaced apart flexible bristles while at least partially entangling the fibers, wherein upon contact with the one or more needles, the spaced apart flexible bristles bend over, and wherein after the contact, the spaced apart flexible bristles recover to an upright position.

Clause 75. The method of clause 74, wherein moving the needle-punch tool in the x-y plane comprises moving the needle-punch tool along a curvilinear tool path.

Clause 76. The method of clause 75, wherein moving the needle-punch tool along the curvilinear tool path comprises moving the needle-punch tool in both an x-direction and a y-direction in the x-y plane.

Clause 77. The method of any of clauses 74 through 76, wherein the one or more needles comprise reverse-barb needles, and wherein at least partially entangling the fibers comprises pulling the fibers through a textile layer positioned between the fibers and the needle-punch tool.

Clause 78. The method of clause 77, wherein the textile layer comprises a fiber layer deposited on top of the fibers.

Clause 79. The method of any of clauses 74 through 78, wherein moving the needle-punch tool in the x-y plane comprises moving the needle-punch tool along a tool path corresponding to a peripheral border of a two-dimensional shape.

Clause 80. The method of clause 79, wherein the peripheral border corresponds to an outer portion of an apparel-article pattern piece.

Clause 81. A wearable article comprising: a pattern piece extending in an x-y plane and having a thickness in a z-direction, the pattern piece comprising: a plurality of textile layers, wherein layers of the plurality of textile layers are stacked in the z-direction; the plurality of textile layers comprising a first textile layer and a second textile layer; the first textile layer comprising a first zone in a first area of the x-y plane and a second zone in a second area of the x-y plane; the first zone comprising first fibers that are entangled with the second textile layer, the first zone being associated with a textile property; and the second zone comprising second fibers that are entangled with the second textile layer, the second zone being associated with the textile property, wherein a first measure of the textile property in the first zone is different from a second measure of the textile property in the second zone.

Clause 82. The wearable article of clause 81, wherein the second textile layer comprises a woven textile layer.

Clause 83. The wearable article of clause 81, wherein the second textile layer comprises a nonwoven textile layer.

Clause 84. The wearable article of clause 83, wherein the nonwoven textile layer comprises a fiber web.

Clause 85. The wearable article of clause 83, wherein the nonwoven textile layer comprises a meltblown layer, a spunbond layer, or a spunlace layer.

Clause 86. The wearable article of any one or more of clauses 83 through 85, wherein the nonwoven textile layer comprises an elastic layer.

Clause 87. The wearable article of clause 86, wherein the elastic layer comprises fibers that compositionally comprise a thermoplastic polymer.

Clause 88. The wearable article of clause 87, wherein the thermoplastic polymer comprises a thermoplastic elastomer.

Clause 89. The wearable article of clause 88, wherein the thermoplastic elastomer comprises thermoplastic polyurethane, thermoplastic polyether ester elastomer, or a combination thereof.

Clause 90. The wearable article of any one or more of clauses 81 through 89, wherein: the first fibers and the second fibers comprise a fiber property, and a measure of the fiber property in the first fibers is different than in the second fibers.

Clause 91. The wearable article of clause 90, wherein the fiber property comprises at least one of compositional material, denier, diameter, length, shape, number of components, color, finish, and orientation.

Clause 92. The wearable article of clause 90, wherein: the second fiber property is fiber orientation; and the fiber orientation associated with the second fiber property includes a higher degree of fiber-orientation variability as compared to the fiber orientation associated with the first fiber property.

Clause 93. The wearable article of any one or more of clauses 81 through 92, wherein the textile property comprises at least one of basis weight, modulus of elasticity, elongation, breathability, thermal resistance, pilling, abrasion resistance, color, drapability, hand feel, water resistance, and water repellency.

Clause 94. The wearable article of any one or more of clauses 81 through 93, wherein: the wearable article further comprises: a first seam attaching the pattern piece directly to a second pattern piece or a first trim piece; and a second seam attaching the pattern piece directly to a third pattern piece or a second trim piece; the pattern piece comprises a peripheral boundary having a first segment extending along the first seam and a second segment extending along the second seam; fibers positioned in the first segment comprise a first fiber orientation that is substantially parallel with the first seam; and fibers positioned in the second segment comprise a second fiber orientation that is substantially parallel with the second seam.

Clause 95. The wearable article of clause 94, wherein the first seam is not parallel to the second seam.

Clause 96. The wearable article of clause 95, wherein the first seam is not perpendicular to the second seam.

Clause The wearable article of any one or more of clauses 81 through 96, wherein: the first textile layer comprises a third zone positioned in the x-y plane between the first zone and the second zone; the third zone comprises third fibers that are entangled with the second textile layer, the third zone being associated with the textile property, wherein a third measure of the textile property in the third zone is between the first measure and the second measure.

Clause 98. The wearable article of any one or more of clauses 81through 96, wherein: the first textile layer comprises a third zone positioned in the x-y plane between the first zone and the second zone; and the third zone comprises third fibers that are homogenous with fibers of the second textile layer.

Clause 99. The wearable article of any one or more of clauses 81through 96, wherein: the first textile layer comprises a third zone that is positioned in the x-y plane and that forms a peripheral border around one or more sides of the first zone; and the third zone comprises third fibers that are entangled with the second textile layer, the third zone being associated with the textile property, wherein a third measure of the textile property in the third zone is different than the first measure.

Clause 100. The wearable article of any one or more of clauses 81 to 99, wherein the plurality of textile layers comprises a third textile layer.

Clause 101. The wearable article of clause 100, wherein the first textile layer is positioned, in the z-direction, between the second textile layer and the third textile layer.

Clause 102. The wearable article of clause 100, wherein the second textile layer is positioned, in the z-direction, between the first textile layer and the third textile layer.

Clause 103. A wearable article comprising: a first pattern piece extending in an x-y plane and having a thickness in a z-direction, the first pattern piece comprising a nonwoven textile layer; a second pattern piece; a seam attaching the first pattern piece to the second pattern piece, the seam extending in a first orientation in the x-y plane; the first pattern piece comprising: a peripheral boundary having a segment extending along the seam; and first fibers of the nonwoven textile layer that are positioned in the first segment and that comprise a first fiber orientation, which is aligned with the first orientation of the seam.

Clause 104. The wearable article of clause 103, wherein: the wearable article further comprises: a third pattern piece or a trim piece; a second seam attaching the first pattern piece to the third pattern piece or to the trim piece, wherein the second seam extends in a second orientation in the x-y plane, which is different from the first orientation; the peripheral boundary comprises: a second segment extending along the second seam; and second fibers of the nonwoven textile layer that are positioned in the second segment and that comprise a second fiber orientation, which is aligned with the second orientation of the second seam.

Clause 105. The wearable article of clause 104, wherein the first orientation is angled relative to the second orientation.

Clause 106. The wearable article of any of clauses 104 or 105, wherein the first orientation is not parallel relative to the second orientation.

Clause 107. The wearable article of any one or more of clauses 104 through 106, wherein the first orientation is not perpendicular to the second orientation.

Clause 108. The wearable article of any one or more of clauses 104 through 107, wherein the first fibers and the second fibers are positioned in a fiber web, which connects the first fibers to the second fibers in the x-y plane.

Clause 109. The wearable article of any one or more of clauses 104 through 108, wherein: the first fibers are comprised in a first zone in a first area of the x-y plane, the first zone being associated with a textile property; and the first pattern piece comprises a second zone in a second area of the x-y plane; the second zone that comprises third fibers and that is associated with the textile property, wherein a first measure of the textile property in the first zone is different from a second measure of the textile property in the second zone.

Clause 110. The wearable article of clause 109, wherein: the first fibers and the third fibers comprise a fiber property, and a measure of the fiber property in the first fibers is different than in the second fibers.

Clause 111. The wearable article of clause 110, wherein the fiber property comprises at least one of compositional material, denier, diameter, length, shape, number of components, color, finish, and orientation.

Clause 112. The wearable article of clause 109 or clause 110, wherein the textile property comprises at least one of basis weight, modulus of elasticity, elongation, breathability, thermal resistance, pilling, abrasion resistance, color, drapability, hand feel, water resistance, and water repellency.

Clause 113. The wearable article of any one or more of clauses 104 through 112, wherein: the first pattern piece comprises a plurality of textile layers, wherein layers of the plurality of textile layers are stacked in the z-direction; the plurality of textile layers comprises the nonwoven textile layer and a second textile layer; and the first fibers and the second fibers are entangled with the second textile layer.

Clause 114. The wearable article of clause 113, wherein the second textile layer comprises a woven textile layer.

Clause 115. The wearable article of clause 113, wherein the second textile layer comprises a second nonwoven textile layer.

Clause 116. The wearable article of clause 115, wherein the second nonwoven textile layer comprises a fiber web.

Clause 117. The wearable article of clause 115, wherein the second nonwoven textile layer comprises a meltblown layer, a spunbond layer, or a spunlace layer.

Clause 118. The wearable article of any one or more of clauses 115 through 117, wherein the second nonwoven textile layer comprises an elastic layer.

Clause 119. The wearable article of clause 118, wherein the elastic layer comprises fibers that compositionally comprise a thermoplastic polymer.

Clause 120. The wearable article of clause 119, wherein the thermoplastic polymer comprises a thermoplastic elastomer.

Clause 121. The wearable article of clause 120, wherein the thermoplastic elastomer comprises thermoplastic polyurethane, thermoplastic polyether ester elastomer, or a combination thereof.

Clause 122. A wearable article comprising: a composite textile comprising an innermost face and an outermost face, wherein the innermost face, as compared to the outermost face, is configured to be positioned closer to a skin surface of a wearer when the wearable article is worn; the composite textile comprising a first textile layer and a second textile layer, wherein the second textile layer comprises a fiber web and, relative to the first textile layer, is positioned closer to the innermost face; and the outermost face comprising a first zone comprising the first textile and comprising a second zone comprising fibers of the fiber web that extend from the fiber web, through the first textile, and form the outermost face in the second zone, wherein the fibers comprise a different color than the first textile.

Clause 123. The wearable article of clause 122, wherein at least a portion of the fibers of the fiber web that form the outermost face in the second zone comprise fiber loops.

Clause 124. The wearable article of clause 122 or clause 123, wherein the first textile layer comprises a second fiber web, and wherein the first zone comprises a different entanglement parameter than the second zone.

Clause 125. The wearable article of clause 124, wherein the different entanglement parameter comprises a stitch density.

Clause 126. The wearable article of any of clauses 122 to 125, wherein the second zone comprises a peripheral boundary.

Clause 127. The wearable article of clause 126, wherein the peripheral boundary comprises a 2D shape.

Clause v128. A wearable article comprising: a composite textile comprising an innermost face and an outermost face, wherein the innermost face, as compared to the outermost face, is configured to be positioned closer to a skin surface of a wearer when the wearable article is worn; the composite textile comprising a first entangled fiber web and a second entangled fiber web, wherein the second entangled fiber web is positioned closer to the innermost face; and the outermost face comprising a first zone and a second zone, wherein the first zone comprises, as compared to the second zone, different fiber entanglement parameters.

Clause 129. The wearable article of clause 128, wherein the first zone comprises, as compared to the second zone, a higher stitch density.

Clause 130. The wearable article of clause 128 or clause 129, wherein the first zone comprises, as compared to the second zone, a higher quantity of fibers from the second entangled fiber web that extend from the second entangled fiber web, through the first entangled fiber web, and onto the outermost face.

Clause 131. The wearable article of clause 130, wherein the fibers from the second entangled fiber web comprise a different color than fibers of the first entangled fiber web.

Clause 132. The wearable article of any of clauses 128 to 131, wherein the first zone comprises a peripheral boundary.

Clause 133. The wearable article of clause 132, wherein the peripheral boundary comprises a 2D shape.

Aspects of the present disclosure have been described with the intent to be illustrative rather than restrictive. Alternative aspects will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

1. A wearable article comprising:
a pattern piece extending in an x-y plane and having a thickness in a z-direction, the pattern piece comprising:
a plurality of textile layers, wherein layers of the plurality of textile layers are stacked in the z-direction;
the plurality of textile layers comprising a first textile layer and a second textile layer;
the first textile layer comprising a first zone in a first area of the x-y plane and a second zone in a second area of the x-y plane;
the first zone comprising first fibers that are entangled with the second textile layer, wherein the first fibers comprise a first measure of a fiber property; and
the second zone comprising second fibers that are entangled with the second textile layer, wherein the second fibers comprise a second measure of the fiber property that is different from the first measure.

2. The wearable article of claim 1, wherein the fiber property comprises at least one of compositional material, denier, diameter, length, shape, number of components, color, finish, and orientation.

3. The wearable article of 2, wherein:
the fiber property comprises fiber orientation; and
the fiber orientation associated with the second fibers comprises a higher fiber-orientation variance as compared to the fiber orientation associated with the first fibers.

4. The wearable article of claim 1, wherein:
the wearable article further comprises:
a first seam attaching the pattern piece directly to a second pattern piece or a first trim piece; and
a second seam attaching the pattern piece directly to a third pattern piece or a second trim piece;
the pattern piece comprises a peripheral boundary having a first segment extending along the first seam and a second segment extending along the second seam;
fibers positioned in the first segment comprise a first fiber orientation that is substantially parallel with the first seam; and
fibers positioned in the second segment comprise a second fiber orientation that is substantially parallel with the second seam.

5. The wearable article of claim 4, wherein the first seam is not parallel to the second seam.

6. The wearable article of claim 5, wherein the first seam is not perpendicular to the second seam.

7. The wearable article of claim 1, wherein:
the first textile layer comprises a third zone positioned in the x-y plane between the first zone and the second zone; and
the third zone comprises third fibers that are entangled with the second textile layer and that comprise a blend of the first fibers and the second fibers.

8. The wearable article of claim 1, wherein:
the first textile layer comprises a third zone that is positioned in the x-y plane and that forms a peripheral border around one or more sides of the first zone; and
the third zone comprises third fibers that are entangled with the second textile layer and that, the third zone being associated with the textile property, wherein a third measure of the textile property in the third zone is different than the first measure.

9. A wearable article comprising:
a first pattern piece extending in an x-y plane and having a thickness in a z-direction, the first pattern piece comprising a nonwoven textile layer;
a second pattern piece;
a seam attaching the first pattern piece to the second pattern piece, the seam extending in a first orientation in the x-y plane; and
the first pattern piece comprising:
a peripheral boundary having a segment extending along the seam; and
first fibers of the nonwoven textile layer that are positioned in the first segment and that comprise a first fiber orientation, which is aligned with the first orientation of the seam.

10. The wearable article of claim 9, wherein:
the wearable article further comprises:
a third pattern piece or a trim piece; and
a second seam attaching the first pattern piece to the third pattern piece or to the trim piece, wherein the second seam extends in a second orientation in the x-y plane, which is different from the first orientation;
the peripheral boundary comprises:
a second segment extending along the second seam; and
second fibers of the nonwoven textile layer that are positioned in the second segment and that comprise a second fiber orientation, which is aligned with the second orientation of the second seam.

11. The wearable article of claim 10, wherein the first orientation is angled relative to the second orientation.

12. The wearable article of claim 11, wherein the first orientation is not parallel relative to the second orientation.

13. The wearable article of claim 11, wherein the first orientation is not perpendicular to the second orientation.

14. The wearable article of claim 10, wherein the first fibers and the second fibers are positioned in a fiber web, which connects the first fibers to the second fibers in the x-y plane.

15. A wearable article comprising:
a pattern piece extending in an x-y plane and having a thickness in a z-direction, the pattern piece comprising:
a plurality of textile layers, wherein layers of the plurality of textile layers are stacked in the z-direction;
the plurality of textile layers comprising a first textile layer and a second textile layer;
the first textile layer comprising a first zone in a first area of the x-y plane and a second zone in a second area of the x-y plane;
the first zone comprising first fibers that are entangled with the second textile layer, wherein the first fibers comprise a first measure of fiber-orientation variance; and
the second zone comprising second fibers that are entangled with the second textile layer, wherein the second fibers comprise a second measure of fiber-orientation variance that is larger than the first measure.

16. The wearable article of claim 15, wherein the first zone, as compared to the second zone, is closer to a seam that attaches the pattern piece to another pattern piece.

17. The wearable article of claim 15, wherein the first zone comprises a peripheral boundary around at least a portion of the second zone.
